(19) United States
(12) Patent Application Publication
(10) Pub. No.: US 2002/0029259 A1
(43) Pub. Date: Mar. 7, 2002

(54) Remote operation system and remote operation method thereof

(75) Inventor: Hidehiko Okada, Tokyo (JP)

Correspondence Address: FOLEY & LARDNER, Washington Harbour, 3000 K Street, N.W., Suite 500, Washington, DC, 20007-5109, US

(73) Assignee: NEC CORPORATION

(21) Appl. No.: 09/910,778

(22) Filed: Jul. 24, 2001

(30) Foreign Application Priority Data
Jul. 26, 2000 (JP) 2000-225930

(51) Int. Cl. G06F 15/16

(52) U.S. Cl. 709/219; 709/229

(57) ABSTRACT

A remote operation system includes a screen analysis unit for analyzing the contents displayed on a screen, a screen information transmission unit for transmitting data of screen information output by the screen analysis unit to a terminal device, an operation execution unit for receiving user's operation to execute predetermined processing corresponding to the operation and a screen change detection unit for detecting a change of display on the screen, in which the screen analysis unit detects GUI widgets which is an object displayed in the screen and operable by a user to obtain data of a kind, a name and a position in the screen of the GUI widgets, a hyper-link is set for each GUI widget, when a hyper-link corresponding to each GUI widgets is selected, a web page is generated for transmitting data for identifying the GUI widgets in question and data for identifying operation corresponding to the GUI widgets in question, and when a screen change caused by the user's operation is completed, the screen analysis unit analyzes the current screen and transmits the analysis to a user's terminal device to update data displayed on the user's terminal device.

### BACKGROUND OF THE INVENTION

1. Field of the Invention

The present invention relates to a remote operation system which realizes remote operation of an information processing device from another information processing device through a communication network, a remote operation method thereof and a recording medium which records a remote operation program.

2. Description of the Related Art

In conventional electronic computer systems, a remote operation system has been widely used in which a server is operated from an external terminal through a communication network.

This remote operation enables users to freely operate a computer and an apparatus located at places remote from the users and also enables numbers of users to share a high-performance server and operate a server from a plurality of terminals (or unspecified number of terminals connected to a communication network).

In addition, in the conventional remote operation systems, a server on the side of receiving remote operation is provided with a function of receiving user's log-in and operation through a network, while a terminal on the side of conducting remote operation is provided with virtual terminal software or a terminal emulator for remote operation in order to realize remote operation.

Among virtual terminal software for conducting remote operation of a server from an external terminal is, for example, telnet. Telnet is the software intended for conducting remote operation through a CUI (character based user interface) which is a system for entering instruction commands as characters. In the software, with a computer on which such operating system as UNIX adapted to operation by CUI runs as a target of remote operation, an operation screen in the CUI environment on the computer to be operated is displayed at a terminal located on a user's side and the user enters a command into the operation screen, thereby realizing remote operation.

As described in the foregoing, in a remote operation system in the CUI environment, an operation screen in the CUI environment of a computer to be operated is displayed as the whole or one frame of a display of a terminal, a command input by a user is executed at the computer to be operated and a response corresponding to the execution and the like are displayed on the operation screen.

In recent years, there is a wide spread of computers having an operation environment for a GUI (graphical user interface) in which graphical elements displayed on a screen such as an icon and a window are operated by a pointing device such as a mouse, and such computers having the GUI environment often fail to be adapted to such operation as input of an instruction command in a CUI.

Even such computers in the GUI environment, however, can be remotely operated in the same manner as that in the CUI environment by providing a terminal on the side of conducting remote operation with virtual terminal software adapted to the GUI environment.

Virtual terminal software in the GUI environment connects to a computer to be operated to obtain data of its display screen and displays the data in a display of a terminal. Then, when a user conducts GUI operation such as clicking of a mouse within the display screen, the software instructs the computer to be operated to execute processing corresponding to the operation, thereby conducting remote operation.

This arrangement enables the display screen of the computer to be operated to be displayed at a user's terminal and the computer to be operated to be remotely operated through operation of the GUI.

Among virtual terminal software adapted to the GUI environment are, for example, “Win Share” (product of NEC Corp.), “Desktop On-Call” (product of IBM Japan, Ltd.) and “pcANYWHERE32” (product of Symantec Corporation). On the other hand, conventional techniques of a remote operation systems which conduct remote operation of a computer having the GUI environment include the technique of the remote computer operation device disclosed in Japanese Patent Laying-Open (Kokai) No. Heisei 05-035622.

As described in the foregoing, conventional remote operation systems for a computer having the GUI environment have the following problems.

Firstly, conventional remote operation systems require that a terminal on the side of conducting remote operation should be provided with software for remote processing or such a special function of realizing the related function as a semiconductor circuit.

In addition, since a GUI environment of a computer to be operated varies with a kind of the computer or an OS (operating system) to be used, it is necessary to in advance adopt such virtual terminal software therefor as adapted to the computer to be operated.

Moreover, software or the like for remote operation by an GUI needs detailed and complicated setting at the time of installation etc., occupies much space in a hard disc and costs much in some cases. It is therefore troublesome to provide a terminal with such software.

Under these circumstances, users are not allowed to freely select a terminal for conducting remote operation and need to use a special terminal having a function of remote operation adapted to a computer to be operated. For example, it was impossible to freely select an information processing terminal or a communication terminal at hand to conduct remote operation.

One of conventional art for solving this problem is the remote operation method disclosed in Japanese Patent Laying-Open (Kokai) No. Heisei 10-301874.

In the conventional art disclosed in Japanese Patent Laying-Open No. Heisei 10-301874, automatic generation of a web page which displays image data of a display screen of a server as a computer to be operated leads to display of image of the display screen on a web browser of a user's terminal.

As to operation by a user using a GUI, when the user executes such operation with image data of a display screen as clicking of a mouse, the use of Java applets for display of image data of a display screen leads to automatic notification of the operation to a server side, whereby the server executes processing corresponding to the operation. Image of a display screen of the server which is displayed in a web browser of a user's terminal will be updated upon reception of operation from the user or in other case.

Therefore, a user's terminal only needs to have a communication function such as the Internet and a web browser and not a special function for remote operation.

Image data of a display screen of a computer, however, is of a considerably large volume and transmission of the data to a user's terminal to receive remote operation requires a high-speed communication line and a long communication time. While no special function is required of a user's terminal, a large volume of image data should be transmitted and received frequently for communication, which is not suitable for current communication infrastructure such as the Internet.

Secondly, in conventional remote operation systems, a terminal on the side of conducting remote operation needs to be provided with a display capable of displaying a display screen of a computer to be operated as it is.

For example, the terminals should be such information processing terminals having a broad display screen as a personal computer and a notebook-sized personal computer, and small-sized communication terminals including a cellular phone and a PHS (personal handy-phone system) are not capable of conducting remote operation of an external computer.

These communication terminals including a cellular phone and a PHS have their displays considerably small and allow a small number of colors to be displayed. Some of them are capable of displaying characters only and not images and therefore are not allowed to display a screen of a computer as it is.

On the other hand, these portable communication terminals are now widespread among numbers of users and conveniently carried. Enabling use of such terminals for remote operation of an external computer will make them more useful.

### SUMMARY OF THE INVENTION

A first object of the present invention is to provide a remote operation system which eliminates the above-described shortcomings of conventional art and enables small-sized portable communication terminals currently on the market such as a cellular phone and a PHS to conduct remote operation of an external computer by using a GUI and a remote operation method thereof, and a recording medium which records a remote operation program.

A second object of the present invention is to provide a remote operation system which eliminates the above-described shortcomings of conventional art and enables remote operation of an external computer using a GUI by freely using a portable communication terminal in user's hand without requiring a terminal on the side of conducting remote operation to have a special function for remote operation and a remote operation method thereof, and a recording medium which records a remote operation program.

According to the first aspect of the invention, a remote operation system for remotely operating a device to be operated through a communication network from an operation side terminal, comprises

screen analysis means for analyzing information displayed on a screen of the device to be operated, and

screen information transmission means for transmitting data of an analysis result obtained by the screen analysis means to the operation side terminal to display the data on the operation side terminal.

In the preferred construction, the remote operation system further comprises operation execution means for causing the device to be operated to execute predetermined processing corresponding to user's operation conducted using the operation side terminal.

In another preferred construction, the remote operation system further comprises screen information conversion means for converting data of an analysis result obtained by the screen analysis means into data suitable for the transmission to the operation side terminal or for displaying on a screen of the operation side terminal, wherein

the screen information transmission means transmits data of a result of conversion by the screen information conversion means to the operation side terminal to display the data on the operation side terminal.

In another preferred construction, the remote operation system further comprises conversion rule registration means for registering and recording rules for converting data of an analysis result obtained by the screen analysis means into data suitable for the transmission to the operation side terminal or for displaying on the screen of the operation side terminal, wherein

the screen information conversion means converts data of an analysis result obtained by the screen analysis means based on the conversion rules recorded in the conversion rule registration means.

In another preferred construction, the remote operation system further comprises device characteristic detection means for detecting device characteristics of the operation side terminal, wherein

the screen information conversion means converts data of an analysis result obtained by the screen analysis means based on device characteristics detected by the device characteristic detection means and conversion rules recorded in the conversion rule registration means.

In another preferred construction, the remote operation system further comprises screen change detection means for detecting a change in display of the screen of the device to be operated, wherein

at a time when a change occurred in display of the screen is completed, the screen analysis means analyzes the current screen of the device to be operated.

In another preferred construction, the device to be operated is an information processing device having a GUI, and the screen analysis means detects GUI widgets displayed on the screen of the device to be operated to obtain attribute data of the GUI widgets.

In another preferred construction, the attribute data of the GUI widgets includes at least one of a kind of the GUI widgets, a name of the GUI widgets and a location of the GUI widgets in the screen.

In another preferred construction, the conversion rule registration means has registration of rules for converting data of an analysis result obtained by the screen analysis means into a web page that can be displayed by a web browser,

the screen information conversion means converts data of an analysis result obtained by the screen analysis means into a web page based on the rules,

the web page includes, for GUI widgets operable by a user among GUI widgets detected by the screen analysis means, a hyper-link corresponding to the GUI widgets in question, and

when the hyper-link is selected, data for identifying GUI widgets corresponding to the hyper-link in question and data for identifying operation for the GUI widgets in question are transmitted to the operation execution means.

In another preferred construction, the conversion rule registration means has registration of rules for converting data of an analysis result obtained by the screen analysis means into a text of electronic mail.

In another preferred construction, the operation execution means receives electronic mail including information of user's operation conducted using the operation side terminal, analyzes the received electronic mail to identify the user's operation, and executes the operation in question.

In another preferred construction, data of an analysis result obtained by the screen analysis means is data of an XML format.

In another preferred construction, the operation side terminal is a portable communication terminal having a character data transmission and reception function.

In another preferred construction, the communication network is the Internet.

In another preferred construction, the screen analysis means, when moving picture or still picture is displayed on the screen of the device to be operated, detects the display in question to extract picture data of the display in question, and

the screen information transmission means transmits the picture data extracted by the screen analysis means to the operation side terminal to display the data on the operation side terminal.

In another preferred construction, the screen analysis means, when moving picture or still picture is displayed on the screen of the device to be operated, detects the display in question to extract picture data of the display in question, and

the screen information conversion means converts the picture data extracted by the screen analysis means into data suitable for the transmission to the operation side terminal or for displaying on the screen of the operation side terminal.

In another preferred construction, device characteristics of the operation side terminal detected by the device characteristic detection means include at least one of an inherent ID of the operation side terminal, a kind of machine, a processing rate, a communication rate, communication costs per unit volume of data, communication costs per unit time, a data format that can be displayed on a screen, a playable sound data format, executable program and script formats, a volume of data receivable at one time, a color that can be displayed, a character font that can be displayed, a screen resolution, a physical length of a screen in a vertical direction and a lateral direction and the number of characters that can be displayed within one screen in the vertical direction and the lateral direction.

According to the second aspect of the invention, a remote operation system for remotely operating a device to be operated through a communication network from an operation side terminal, wherein

the device to be operated comprises

screen analysis means for analyzing the contents displayed on a screen of the device to be operated, and

screen information transmission means for transmitting data of an analysis result obtained by the screen analysis means to the operation side terminal to display the data on the operation side terminal.

In the preferred construction, the remote operation system further comprises operation execution means for causing the device to be operated to execute predetermined processing corresponding to user's operation conducted using the operation side terminal.

In another preferred construction, the remote operation system further comprises screen information conversion means for converting data of an analysis result obtained by the screen analysis means into data suitable for the transmission to the operation side terminal or for displaying on a screen of the operation side terminal, wherein

the screen information transmission means transmits data of a result of conversion by the screen information conversion means to the operation side terminal to display the data on the operation side terminal.

In another preferred construction, the remote operation system further comprises conversion rule registration means for registering and recording rules for converting data of an analysis result obtained by the screen analysis means into data suitable for the transmission to the operation side terminal or for displaying on the screen of the operation side terminal, wherein

the screen information conversion means converts data of an analysis result obtained by the screen analysis means based on the conversion rules recorded in the conversion rule registration means.

In another preferred construction, the remote operation system further comprises device characteristic detection means for detecting device characteristics of the operation side terminal, wherein

the screen information conversion means converts data of an analysis result obtained by the screen analysis means based on device characteristics detected by the device characteristic detection means and conversion rules recorded in the conversion rule registration means.

In another preferred construction, the remote operation system further comprises screen change detection means for detecting a change in display of the screen of the device to be operated, wherein

at a time when a change occurred in display of the screen is completed, the screen analysis means analyzes the current screen of the device to be operated.

In another preferred construction, the device to be operated is an information processing device having a GUI, and the screen analysis means detects GUI widgets displayed on the screen of the device to be operated to obtain attribute data of the GUI widgets.

In another preferred construction, the attribute data of the GUI widgets includes at least one of a kind of the GUI widgets, a name of the GUI widgets and a location of the GUI widgets in the screen.

In another preferred construction, the conversion rule registration means has registration of rules for converting data of an analysis result obtained by the screen analysis means into a web page that can be displayed by a web browser,

the screen information conversion means converts data of an analysis result obtained by the screen analysis means into a web page based on the rules,

the web page includes, for GUI widgets operable by a user among GUI widgets detected by the screen analysis means, a hyper-link corresponding to the GUI widgets in question, and

when the hyper-link is selected, data for identifying GUI widgets corresponding to the hyper-link in question and data for identifying operation for the GUI widgets in question are transmitted to the operation execution means.

In another preferred construction, the conversion rule registration means has registration of rules for converting data of an analysis result obtained by the screen analysis means into a text of electronic mail.

In another preferred construction, the operation execution means receives electronic mail including information of user's operation conducted using the operation side terminal, analyzes the received electronic mail to identify the user's operation, and executes the operation in question.

In another preferred construction, data of an analysis result obtained by the screen analysis means is data of an XML format.

In another preferred construction, the operation side terminal is a portable communication terminal having a character data transmission and reception function.

In another preferred construction, the communication network is the Internet.

In another preferred construction, the screen analysis means, when moving picture or still picture is displayed on the screen of the device to be operated, detects the display in question to extract picture data of the display in question, and

the screen information transmission means transmits the picture data extracted by the screen analysis means to the operation side terminal to display the data on the operation side terminal.

In another preferred construction, the screen analysis means, when moving picture or still picture is displayed on the screen of the device to be operated, detects the display in question to extract picture data of the display in question, and

the screen information conversion means converts the picture data extracted by the screen analysis means into data suitable for the transmission to the operation side terminal or for displaying on the screen of the operation side terminal.

In another preferred construction, device characteristics of the operation side terminal detected by the device characteristic detection means include at least one of an inherent ID of the operation side terminal, a kind of machine, a processing rate, a communication rate, communication costs per unit volume of data, communication costs per unit time, a data format that can be displayed on a screen, a playable sound data format, executable program and script formats, a volume of data receivable at one time, a color that can be displayed, a character font that can be displayed, a screen resolution, a physical length of a screen in a vertical direction and a lateral direction and the number of characters that can be displayed within one screen in the vertical direction and the lateral direction.

According to the third aspect of the invention, a remote operation method of remotely operating a device to be operated through a communication network from an operation side terminal comprises

a screen analysis step of analyzing information displayed on a screen of the device to be operated, and

screen information transmission step of transmitting data of an analysis result obtained by the screen analysis step to the operation side terminal to display the data on the operation side terminal.

In the preferred construction, the remote operation method further comprises an operation execution step of causing the device to be operated to execute predetermined processing corresponding to user's operation conducted using the operation side terminal.

In another preferred construction, the remote operation method further comprises a screen information conversion step of converting data of an analysis result obtained by the screen analysis step into data suitable for the transmission to the operation side terminal or for displaying on a screen of the operation side terminal, wherein

at the screen information transmission step, data of a result of conversion by the screen information conversion step is transmitted to the operation side terminal to display the data on the operation side terminal.

In another preferred construction, the remote operation method further comprises a conversion rule registration step of registering rules for converting data of an analysis result obtained by the screen analysis step into data suitable for the transmission to the operation side terminal or for displaying on the screen of the operation side terminal, wherein

at the screen information conversion step, data of an analysis result obtained by the screen analysis step is converted based on the conversion rules registered at the conversion rule registration step.

In another preferred construction, the remote operation method further comprises a device characteristic detection step of detecting device characteristics of the operation side terminal, wherein

at the screen information conversion step, data of an analysis result obtained by the screen analysis step is converted based on device characteristics detected by the device characteristic detection step and conversion rules registered at the conversion rule registration step.

In another preferred construction, the remote operation method further comprises a screen change detection step of detecting a change in display of the screen of the device to be operated, wherein

at a time when a change occurred in display of the screen is completed, the contents displayed on the current screen of the device to be operated are analyzed by the screen analysis step.

In another preferred construction, the device to be operated is an information processing device having a GUI, and

at the screen analysis step, GUI widgets displayed on the screen of the device to be operated is detected to obtain attribute data of the GUI widgets.

In another preferred construction, the attribute data of the GUI widgets includes at least one of a kind of the GUI widgets, a name of the GUI widgets and a location of the GUI widgets in the screen.

In another preferred construction, at the conversion rule registration step, rules are registered for converting data of an analysis result obtained by the screen analysis step into a web page that can be displayed by a web browser,

at the screen information conversion step, data of an analysis result obtained by the screen analysis step is converted into a web page based on the rules,

the web page includes, for GUI widgets operable by a user among GUI widgets detected by the screen analysis step, a hyper-link corresponding to the GUI widgets in question, and

at the operation execution step, using data for identifying GUI widgets corresponding to the hyper-link in question and data for identifying operation for the GUI widgets in question which are transmitted when the hyper-link is selected, the operation side terminal is caused to execute predetermined processing.

In another preferred construction, at the conversion rule registration step, rules are registered for converting data of an analysis result obtained by the screen analysis step into a text of electronic mail.

In another preferred construction, at the screen analysis step, when moving picture or still picture is displayed on the screen of the device to be operated, the display in question is detected to extract picture data of the display in question, and

at the screen information transmission step, the picture data extracted by the screen analysis step is transmitted to the operation side terminal to display the data on the operation side terminal.

In another preferred construction, at the screen analysis step, when moving picture or still picture is displayed on the screen of the device to be operated, the display in question is detected to extract picture data of the display in question, and

at the screen information conversion step, the picture data extracted by the screen analysis step is converted into data suitable for the transmission to the operation side terminal or for displaying on the screen of the operation side terminal.

In another preferred construction, device characteristics of the operation side terminal detected by the device characteristic detection step include at least one of an inherent ID of the operation side terminal, a kind of machine, a processing rate, a communication rate, communication costs per unit volume of data, communication costs per unit time, a data format that can be displayed on a screen, a playable sound data format, executable program and script formats, a volume of data receivable at one time, a color that can be displayed, a character font that can be displayed, a screen resolution, a physical length of a screen in a vertical direction and a lateral direction and the number of characters that can be displayed within one screen in the vertical direction and the lateral direction.

According to another aspect of the invention, a remote operation program for remotely operating a device to be operated through a communication network from an operation side terminal by controlling an information processing system, which causes execution of,

screen analysis processing of analyzing information displayed on a screen of the device to be operated, and

screen information transmission processing of transmitting data of an analysis result obtained by the screen analysis processing to the operation side terminal to display the data on the operation side terminal.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing a structure of a remote operation system according to a first embodiment of the present invention;

FIG. 2 is a flow chart for use in explaining processing of remote operation according to the first embodiment of the present invention;

FIG. 3 is a flow chart for use in explaining processing of a screen analysis by a screen analysis unit of the first embodiment of the present invention;

FIG. 4 is a diagram showing one example of a window displayed on a GUI screen of a computer;

FIG. 5 is a diagram showing an example of a GUI screen of the computer;

FIG. 6 is a diagram showing one example of a menu in a window;

FIG. 7 is a diagram showing one example of property information of GUI widgets in the first embodiment of the present invention;

FIG. 8 is a diagram showing one example of a coordinate value of GUI widgets;

FIG. 9 is a diagram showing one example of data generated by the screen analysis unit of the first embodiment of the present invention;

FIG. 10 is a diagram showing one example of display, on a terminal device, of the display screen of FIG. 6 analyzed by the screen analysis unit of the first embodiment of the present invention;

FIG. 11 is a diagram showing one example of a display screen obtained when connection to a computer to be operated in the first embodiment of the present invention is established;

FIG. 12 is a diagram showing one example of display, on the terminal device, of the display screen of FIG. 11 analyzed by the screen analysis unit of the first embodiment of the present invention;

FIG. 13 is a diagram showing a state where an icon of Fax is double-clicked on the screen of FIG. 11 to display a window of Fax;

FIG. 14 is a diagram showing one example of display, on the terminal device, of the display screen of FIG. 13 analyzed by the screen analysis unit of the first embodiment of the present invention;

FIG. 15 is a diagram showing a state where a file menu is clicked on the screen of FIG. 13 to display a pull-down menu;

FIG. 16 is a diagram showing one example of display, on the terminal device, of the display screen of FIG. 15 analyzed by the screen analysis unit of the first embodiment of the present invention;

FIG. 17 is a diagram showing a state where an item of transmission is clicked on the screen of FIG. 15 to display a window of Fax transmission;

FIG. 18 is a diagram showing one example of display, on the terminal device, of the display screen of FIG. 17 analyzed by the screen analysis unit of the first embodiment of the present invention;

FIG. 19 is a diagram showing a state where a file in a list box is clicked and selected on the screen of FIG. 17;

FIG. 20 is a diagram showing one example of display, on the terminal device, of the display screen of FIG. 19 analyzed by the screen analysis unit of the first embodiment of the present invention;

FIG. 21 is a diagram showing a state where a window for entry of a Fax number which is the number of a Fax transmission destination is displayed;

FIG. 22 is a diagram showing one example of display, on the terminal device, of the display screen of FIG. 21 analyzed by the screen analysis unit of the first embodiment of the present invention;

FIG. 23 is a diagram showing a state where a window indicative of completion of Fax transmission is displayed;

FIG. 24 is a diagram showing one example of display, on the terminal device, of the display screen of FIG. 23 analyzed by the screen analysis unit of the first embodiment of the present invention;

FIG. 25 is a block diagram showing a structure of a remote operation system according to a second embodiment of the present invention;

FIG. 26 is a diagram showing one example of display, on the terminal device, of the display screen of FIG. 11 analyzed by the screen analysis unit of the second embodiment of the present invention;

FIG. 27 is a diagram showing one example of electronic mail transmitted to a computer from the terminal device of the second embodiment of the present invention;

FIG. 28 is a diagram showing one example of display, on the terminal device, of the display screen of FIG. 17 analyzed by the screen analysis unit of the second embodiment of the present invention;

FIG. 29 is a diagram showing one example of display, on the terminal device, of the display screen of FIG. 21 analyzed by the screen analysis unit of the second embodiment of the present invention;

FIG. 30 is a diagram showing one example of electronic mail transmitted to the computer from the terminal device of the second embodiment of the present invention;

FIG. 31 is a block diagram showing a structure of a remote operation system according to a third embodiment of the present invention;

FIG. 32 is a block diagram showing a structure of a remote operation system according to a fourth embodiment of the present invention;

FIG. 33 is a diagram showing an example of a GUI screen of a computer to be operated in the fourth to sixth embodiments of the present invention;

FIG. 34 is a diagram showing one example of display, on a terminal device, of the display screen of FIG. 33 analyzed by a screen analysis unit of the fourth embodiment of the present invention and showing one example of display, on the terminal device, of the display screen of FIG. 33 converted by a screen information conversion unit of the sixth embodiment of the present invention;

FIG. 35 is a block diagram showing a structure of a remote operation system according to a fifth embodiment of the present invention;

FIG. 36 is a flow chart for use in explaining processing of remote operation according to the fifth embodiment of the present invention;

FIG. 37 is a diagram showing one example of data generated by a screen analysis unit of the fifth embodiment of the present invention;

FIG. 38 is a block diagram showing a structure of a remote operation system according to the sixth embodiment of the present invention;

FIG. 39 is a block diagram showing one specific example of a device structure of the computer to be operated of the present invention.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

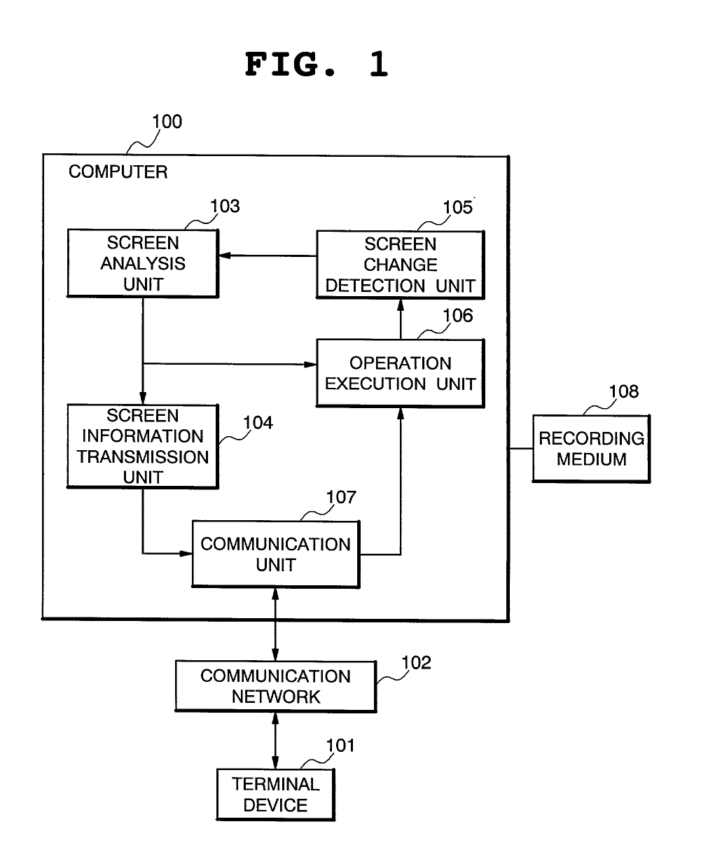

FIG. 1 is a block diagram showing a structure of a remote operation system according to a first embodiment of the present invention.

With reference to FIG. 1, in the remote operation system of the first embodiment, a computer 100 is a device to be remotely operated (operation target device), a terminal device 101 is an operation side terminal which is used by a user for remote operation, and the computer 100 and the terminal device 101 are connected through a communication network 102 to conduct communication for remote operation.

The computer 100 is, for example, an information processing device having a GUI operation environment.

The terminal device 101 is such a terminal communicable through a communication network 102 as a cellular phone or a PHS (personal handy-phone system) and is for use in remote operation of the computer 100 by a user.

Similarly to cellular phones, PHSs and the like on the market which are widely used in these days, the terminal device 101 has a data communication function and a display screen on which data can be displayed.

The communication network 102 is an information communication line for the terminal device 101 of a user and the computer 100 to be remotely operated to communicate with each other for remote operation, for which used are lines including dedicated lines for the Internet, personal computer communication, the Internet for i-mode and the like, and a telephone line and a radio telephone line for the connection with these lines.

With reference to FIG. 1, the computer 100 to be remotely operated includes a screen analysis unit 103, a screen information transmission unit 104, a screen change detection unit 105, an operation execution unit 106 and a communication unit 107.

The screen analysis unit 103 analyzes the contents of a display screen of the computer 100 and outputs an analysis result.

The screen information transmission unit 104 transmits screen information obtained as a result of an analysis by the screen analysis unit to the terminal device 101.

The communication unit 107 communicates with the terminal device 101 through the communication network 102.

The operation execution unit 106 executes processing designated by remote operation or gives an instruction on the execution.

The screen change detection unit 105 detects a change of a display screen of the computer 100.

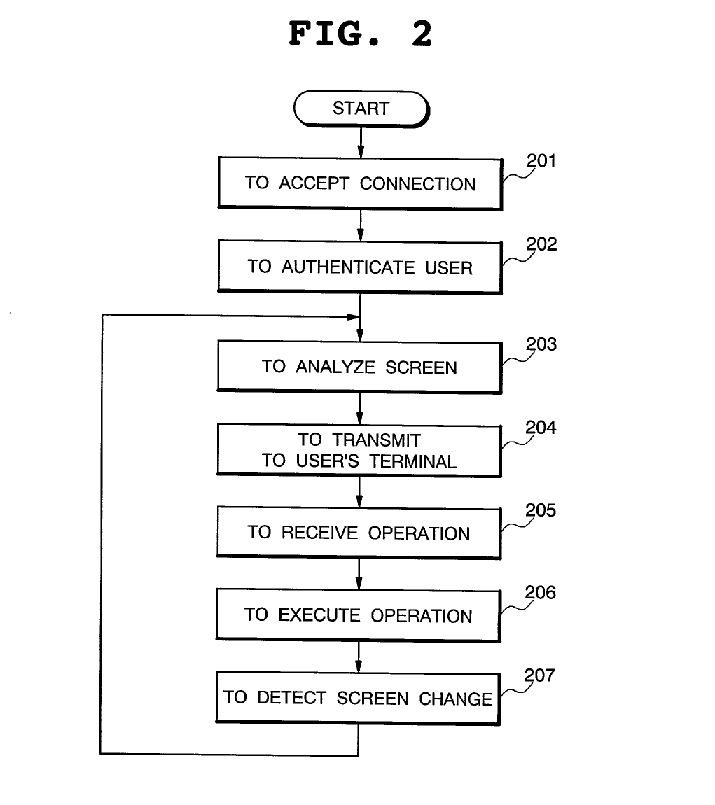

FIG. 2 is a flow chart for use in explaining processing of remote operation of the remote operation system according to the first embodiment.

With reference to FIG. 2, in the remote operation system of the first embodiment, first the computer 100 as a target of remote operation accepts connection from the terminal device 101 of a user (Step 201).

In addition, authenticate the user by accepting input of an ID number and a password for identifying a user or by other method (Step 202) and exclusively for users registered as a user allowed to conduct remote operation and properly authenticated, execute the subsequent communication for remote operation.

Then, the screen analysis unit 103 analyzes a display screen of the computer 100 to be operated (Step 203). In a case, for example, where the computer 100 is a personal computer (PC) or a work station (WS) having a GUI, the unit analyzes a current GUI screen to find what kind of object is being displayed and obtain data of a kind, a name, a location and the like of each object. Objects displayed on the GUI screen are GUI widgets such as a window, an icon, a menu and a button. In this analysis, employed is a method of obtaining data from an OS, for example.

Then, the data obtained by the screen analysis unit 103 is transmitted to the user's terminal device 101 by the screen information transmission unit 104 and displayed on a screen of the user's terminal device 101 (Step 204).

Then, when the user executes operation for the computer 100 by using the terminal device 101, the operation execution unit 106 receives information of the operation and executes the operation on the computer 100 (Steps 205 and 206).

When these steps result in changing display of the screen of the computer 100, the screen change detection unit 105 detects the change. Upon detection of the completion of the change, again execute the processing at Step 203 and the following steps to update data displayed on the screen of the user's terminal device 101.

Next, detailed description will be made of an analysis of the contents of the display screen of the computer 100 conducted by the screen analysis unit 103.

FIG. 3 is a flow chart for use in explaining processing of the screen analysis unit 103 of the present embodiment.

The screen analysis unit 103 obtains information such as a name and a display position of an icon displayed and corresponding application from an OS of the computer 100, for example. As a result, data of various objects displayed in an icon and a window within the screen can be precisely obtained from character data.

The present method of obtaining information can be replaced by an OCR (optical character recognition) method of simply converting image of a character displayed on a screen into character data. The OCR method of converting image into character data, however, has the danger of conversion into inaccurate character data and has such a disadvantage that a part of a window spreading out of the right or left side of a screen might not be read. By adopting the method of obtaining detailed information of each object from the OS of the computer 100, the screen analysis unit 103 of the first embodiment is allowed to spontaneously obtain accurate character data at any time without being affected by a resolution of image, a window display position or the like. This method is also employed for realizing an accessibility applied system which enables an information processing device having a GUI to be used by a user having visual or audio difficulty.

The screen analysis unit 103 of the first embodiment first detects a window being active (active window) among windows displayed on the current GUI screen of the computer 100 to obtain a title of the detected active window (Steps 301 and 302).

An active window is a window in a state of being ready for accepting input through a keyboard, while a title of a window is a character string assigned to the window (also called caption).

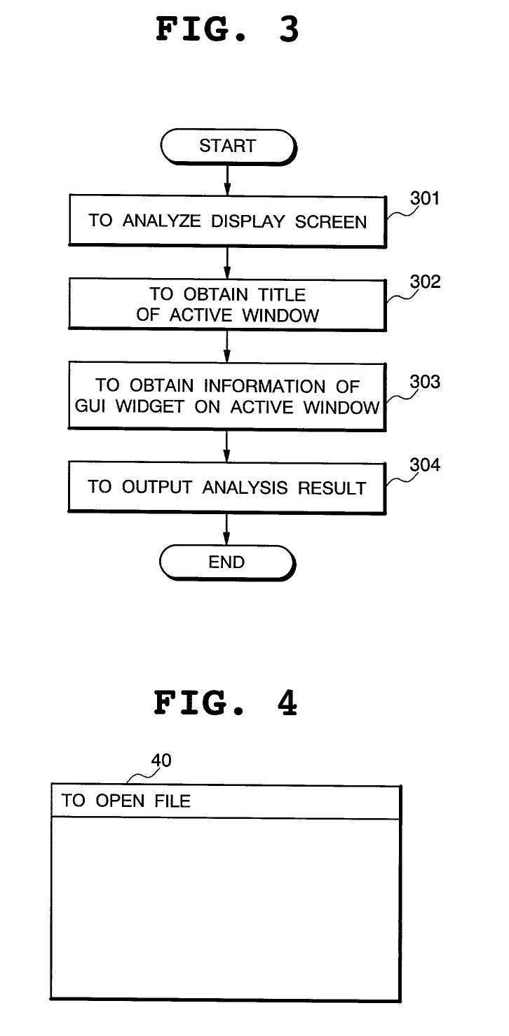

On a GUI screen, it is a common practice that a title of a window is displayed at an upper region of the window (called title bar). A title of a window 40 shown in FIG. 4, for example, is “to open file”.

It is assumed in the first embodiment as in a common OS that when at least one window exists on a screen, one active window exists.

Assume, for example, that on the current GUI screen of the computer 100, three windows 40 are displayed as shown in FIG. 5. Then, one of the three windows 40 is an active window and information of each window 40 is managed by the OS, whereby the screen analysis unit 103 detects the currently active window 40 by obtaining the information from the OS and similarly obtains information such as a title of the window.

In a case where no window 40 is displayed on a current GUI screen 50, a desktop which is the whole of a background region of a window or the like (entire screen) is considered to be currently an active window. Assume here that when the desktop is detected being an active window, a title of the active window is “desktop”.

Upon detecting an active window displayed on the current GUI screen of the computer 100, the screen analysis unit 103 further obtains property information of such objects as a menu, an icon and a button (hereinafter, these objects will be generally referred to as GUI widgets) displayed on the active window (Step 303).

In the first embodiment, property information of GUI widgets represents a kind (menu, icon, button, etc.), a label (such a character string assigned to the GUI widgets as “OK” and “cancel” buttons, which is also called caption) and a coordinate value on the screen.

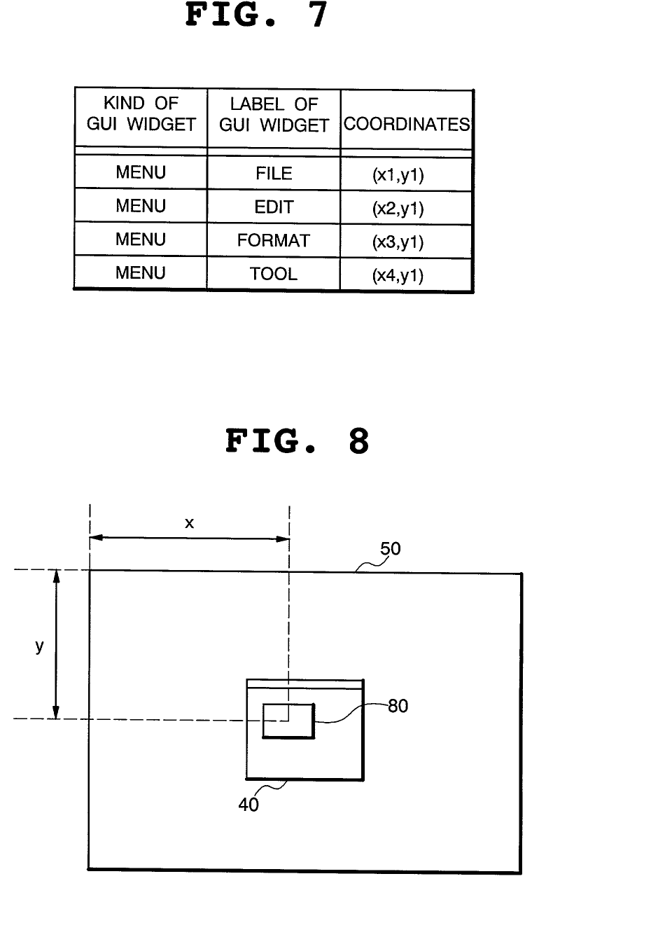

In a case, for example, where an active window displayed on the current GUI screen is a “memo pad” window 40 in which menu items 60 of “file”, “edit”, “format” and “tool” are displayed, the screen analysis unit 103 obtains property information of these four menu items 60 as shown in the example of FIG. 7. x1 to x4 and y1 to y4 in FIG. 7 all represent a certain positive integer.

Here, a coordinate value of GUI widgets on the screen can be expressed by coordinates at one point indicated by using distances from the upper left end point of the screen to the center (or the inside) of the GUI widgets in a lateral direction and a vertical direction.

This means that as illustrated in FIG. 8, when the window 40 exists on the desktop 50 and a GUI widget 80 is located on the window, coordinate values of the GUI widget are expressed as (x, y) by using a coordinate x in the lateral direction and a coordinate y in the vertical direction. Here, x and y are positive integers.

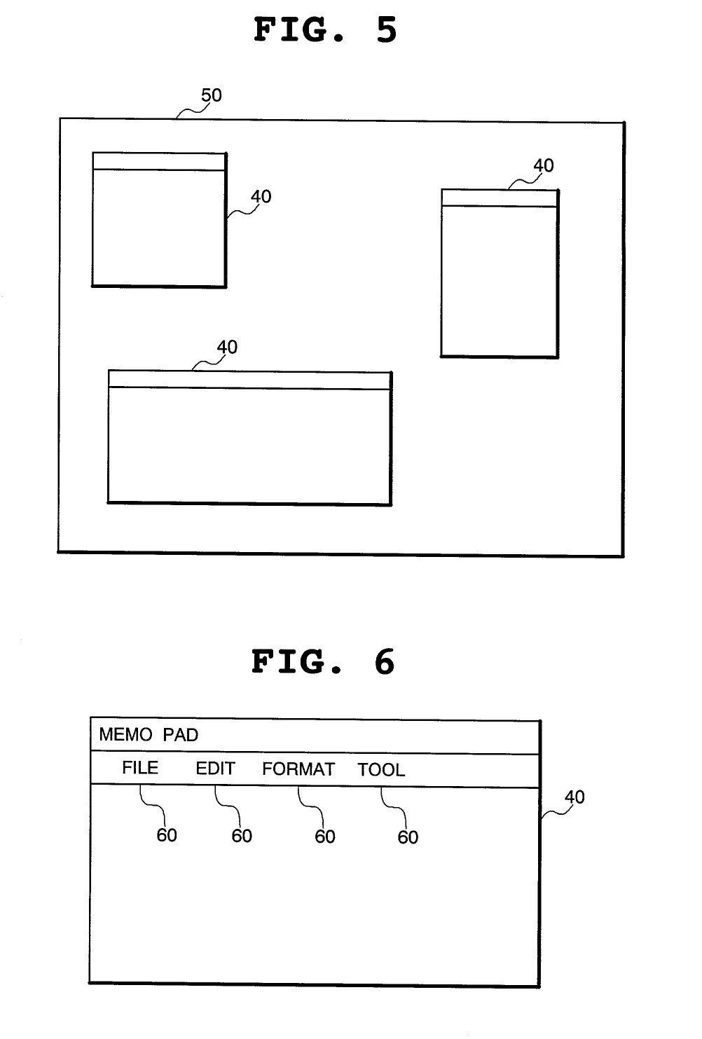

In a case where the active window 40 displayed on the current GUI screen of the computer 100 is the “memo pad” window shown in FIG. 6, the screen analyses unit 103 detects the active window 40 being the “memo pad” window to obtain the title of the window 40 (character string “memo pad”) and further detects the four menu items 60 of the window 40 to obtain property information of each menu item 60 as shown in FIG. 7. As a result, data shown in FIG. 9 is obtained.

The above described analysis of a GUI screen by the screen analysis unit 103 including detection of an active window and acquisition of detailed and accurate information of each kind of GUI widgets can be executed, for example, by the technique recited in “Hidehiko Okada and Toshiyuki Asahi: Tool ┌GUI Tester 2┘ for Evaluating Consistency of GUI Design, Japanese Society of Information Processing Engineers, Human Interface Study Report, Vol. 97, No. 63, pp. 7-12, 1997).

Then, the screen analysis unit 103 outputs such data as shown in FIG. 9 so as to have a predetermined format to the screen information transmission unit 104 (Step 304). The predetermined format is a format that can be displayed at the terminal device 101, which is already known before remote operation is started by the terminal device 101 in the first embodiment. The screen information transmission unit 104 transmits the data received from the screen analysis unit 103 to the terminal device 101. As a result, the data output from the screen analysis unit 103 (i.e. data including the information of the GUI widgets displayed on the current screen of the computer 100) is displayed on the terminal device 101.

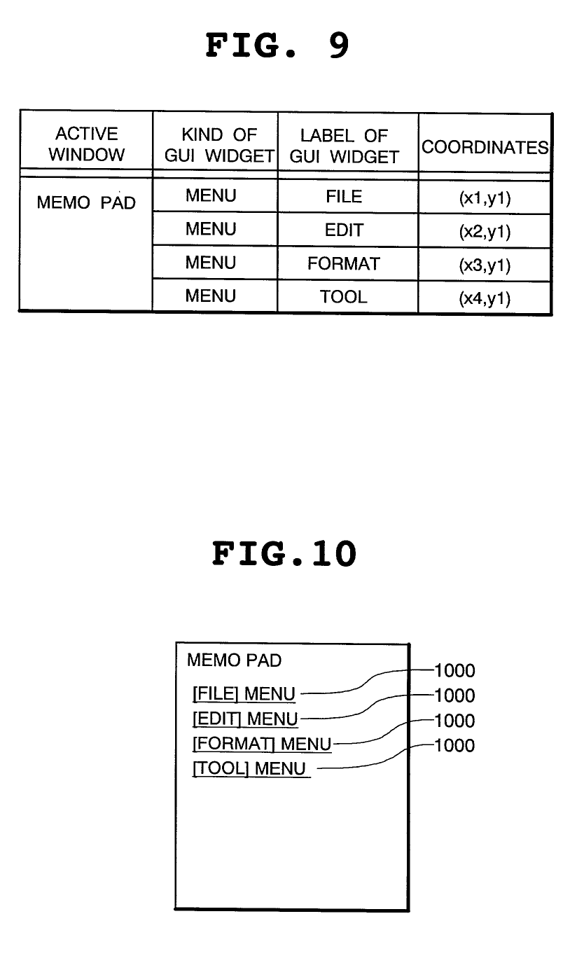

Assume, for example, that the terminal device 101 is provided with a web browser for displaying a web page described with HTML (Hyper-Text Markup Language), so that a web page opened in a web site on a communication network such as the Internet can be displayed. In this case, the screen analysis unit 103 outputs data of a web page having the HTML format and the data is displayed on a screen of the terminal device 101, for example, as shown in FIG. 10. In the example of FIG. 10, first, “memo pad” which is a name of the active window is displayed and then an item name of each menu item 60 is displayed on each line as a hyper-link of HTML which can be selected on the screen of the terminal device 101.

The data file of the HTML format created by the screen analysis unit 103 and transmitted by the screen information transmission unit 104 is displayed on the screen of the terminal device 101 and upon operation on the screen (e.g. selection of a hyper-link), the operation information is transmitted to the operation execution unit 106 through the communication network 102 and the communication unit 107.

The operation execution unit 106 executes, on the computer 100, operation corresponding to the operation executed on the terminal device 101 based on the operation information transmitted from the terminal device 101 and the data of the screen analysis result output from the screen analysis unit 103.

When a hyper-link “file”, which is one of menu item names 1000 displayed on the screen of the terminal device 101 as shown in FIG. 10, for example, is selected, the operation execution unit 106 refers to coordinates corresponding to the relevant menu ((x1, y1) in FIG. 9) based on the data of the screen analysis result output from the screen analysis unit 103 and moves a cursor of a pointing device such as a mouse to the coordinates in question on the screen of the computer 100 to notify the OS or the like of the execution of clicking at the relevant position.

Assume, for example, that in the example described above with reference to FIGS. 6 to 10, the hyper-link “file” shown in FIG. 10 is selected on the screen of the terminal device 101. The operation execution unit 106 finds from the data received from the screen analysis unit 103 that corresponding to the hyper-link “file” in FIG. 10 is the “file” menu 60 in FIG. 6 whose coordinate values are (x1, y1). Then, upon receiving information from the terminal device 101 that the hyper-link “file” of FIG. 10 is selected on the screen of the terminal device 101, the operation execution unit 106 moves the cursor of a pointing device such as a mouse to the position of the coordinate values (x1, y1) and notifies the OS or the like of the execution of clicking at the position in question. As a result, on the screen of the computer 100, the “file” menu 60 of FIG. 6 is selected on the screen of the computer 100.

When operation corresponding to the operation executed on the screen of the terminal device 101 is executed by the operation execution unit 106 on the computer 100, the screen change detection unit 105 detects a change of the GUI screen on the computer 100.

Change of the GUI screen on the computer 100 detected by the screen change detection unit 105 is, for example, opening of a new window, closing of a displayed window, displaying of a pull-down menu or the like.

At a time when no screen change is detected for more than a fixed time period, the screen change detection unit 105 determines that response of the computer 100 to the operation executed by the operation execution unit 106 is completed.

Upon determination of the completion of the response by the screen change detection unit 105, the screen analysis unit 103 again executes an analysis of the current GUI screen of the computer 100 to output data of screen information and the screen information transmission unit 104 transmits data of the screen information to the terminal device 101.

More specifically, when the user executes operation of selecting “file” which is one of the menu item names 1000 displayed on the terminal device 101, the execution is notified to the computer 100 to execute the processing of clicking “file” as the menu item 60, and screen information about a state where a pull-down menu of “file” is displayed after the execution is transmitted as data of a displayable format to the terminal device 101, so that the screen of the user's terminal device 101 is updated to a screen having the new data displayed thereon.

Repetitious execution of the foregoing described processing as one cycle in the same manner hereinafter leads to execution of remote operation.

This cycle will be continued until communication from the terminal device 101 to the computer 100 is completed.

Next, one specific example of remote operation by the remote operation system according to the first embodiment will be described.

First, a user sets up a connection to the computer 100 as an operation target through the communication network 102 by using the terminal device 101 such as a cellular phone. Here, authentication of the user is conducted by a method of inputting an ID number or a password for identifying a user or by other method to start communication for remote operation from the terminal device 101 to the computer 100.

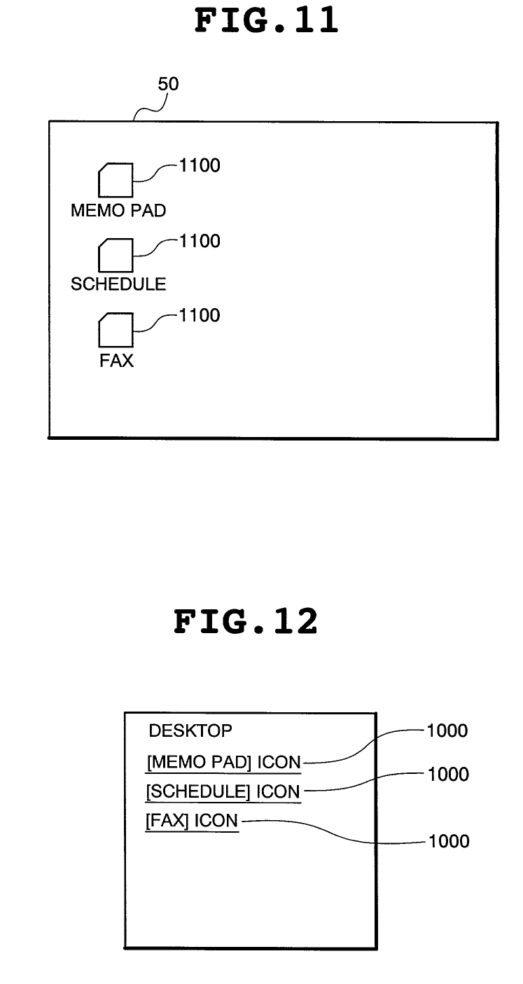

FIG. 11 is a diagram showing one example of the display screen 50 obtained at a time when a connection to the computer 100 as an operation target is established in the present embodiment. In the example of FIG. 11, three icons 1100, “memo pad, “schedule” and “Fax” are displayed on the desktop and window is yet to be displayed.

The state of this display screen shown in FIG. 11 is analyzed by the screen analysis unit 103 of the computer 100. The screen analysis unit 103 obtains information such as a name and a display position of an icon displayed and a corresponding application from the OS of the computer 100 or by other method.

Then, the screen analysis unit 103 outputs the data of the screen information obtained by the analysis in a format which can be displayed on the terminal device 101 on the side of the user (e.g. as a web page described with HTML sentences) to the screen information transmission unit 104. The screen information transmission unit 104 transmits the received data to the terminal device 101.

FIG. 12 is a diagram showing one example of display, on the screen of the terminal device 101, of the information obtained by the analysis of the display screen shown in FIG. 11 and transmitted to the terminal device 101.

In the example of FIG. 12, since window for application is yet to be displayed on the display screen 50 of the computer 100, the indication of “desktop” indicating to that effect and a name of each icon 1000 displayed on the display screen 50 are displayed as a hyper-link.

Next, the user selects the icon name 1000 displayed on the terminal device 101. Here, description will be made of a case where “Fax” is selected.

Then, the terminal device 101 notifies the computer 100 of a request for data of a link destination of “Fax” as a hyper-link and upon reception of the request by the computer 100, the operation execution unit 106 executes operation of double-clicking coordinates on the GUI screen of the computer 100 output from the screen analysis unit 103 for the icon 1100 of “Fax” (i.e. coordinates on the icon 1100 of “Fax”).

Since in the ordinary GUI environment, when an icon on a desktop is double-clicked, processing corresponding to the icon in question is executed, execution of double-clicking is here set as operation corresponding to an icon.

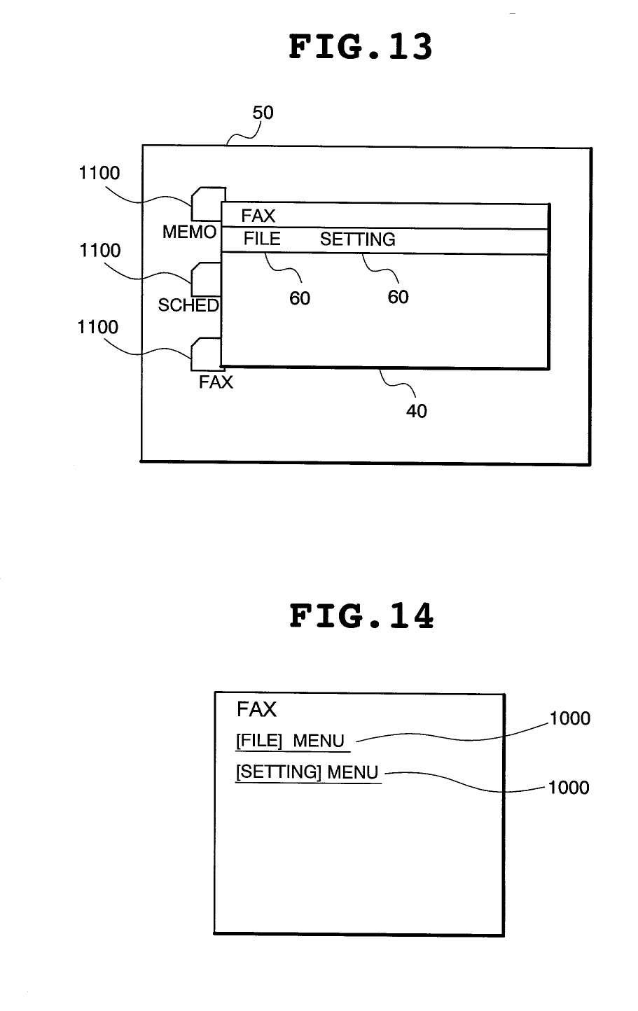

FIG. 13 is a diagram showing a state where a window of Fax is displayed as a result of double-clicking of the icon of Fax on the screen of FIG. 11.

On the screen of FIG. 13, the “Fax” window 40 is displayed which is currently an active window. On the window 40 of “Fax”, the menu items 60 of “file” and “setting” are displayed.

Here, the screen change detection unit 105 detects a change which is new indication of the window 40 within the screen 50 and upon determination of the completion of the response because of detection of no change on the screen more than a fixed time thereafter, instructs the screen analysis unit 103 to conduct an analysis of the screen.

Again, the screen analysis unit 103 analyzes the screen and outputs the analysis result as a web page of HTML, so that the web page is displayed on the screen of the terminal device 101.

FIG. 14 is a diagram showing one example of display, on the terminal device 101, of the information of the display screen shown in FIG. 13.

In display of the terminal device 101 shown in FIG. 14, first, Fax which is the name of an active window is displayed and then “file” and “setting” which are names of menu items of the window of Fax are displayed as hyper-links.

Here, when the user selects the menu item name 1000 of “file” as a hyper-link, the operation is similarly notified to the side of the computer 100, whereby the operation execution unit 106 executes the operation of clicking “file” as the menu item 60 on the GUI screen 50 of FIG. 13.

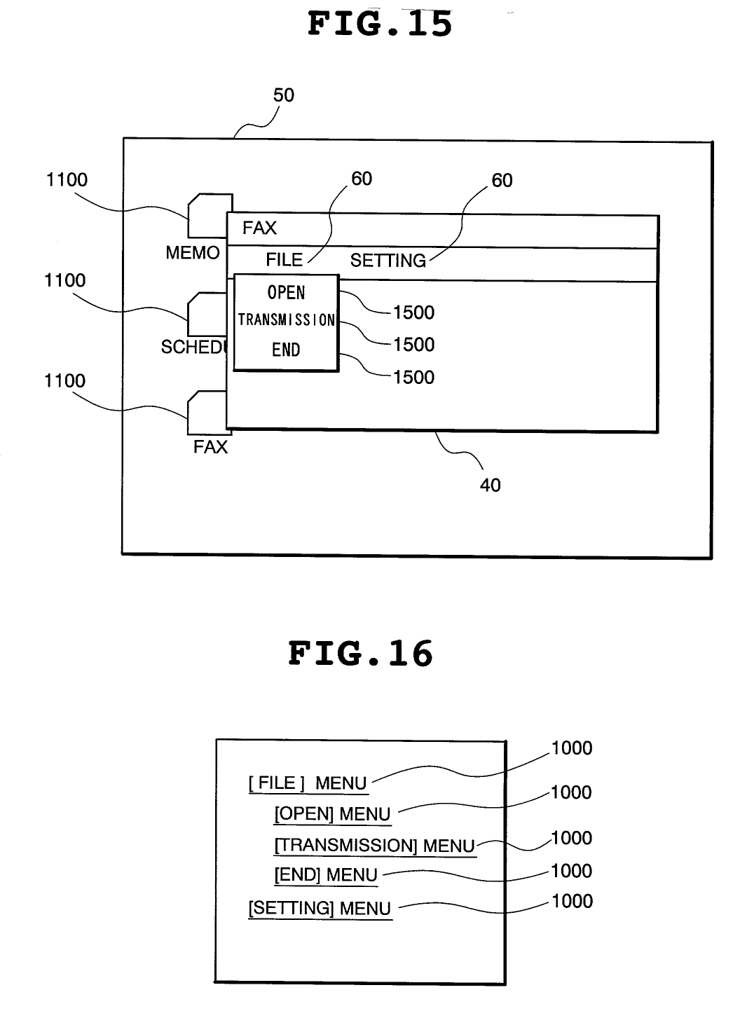

FIG. 15 shows a state where a pull-down menu is displayed as a result of clicking the menu item “file” on the screen of FIG. 13, in which pull-down menu displayed are three sub-menu items 1500, “open”, “transmission” and “end”.

In the same manner, the screen change detection unit 105 detects a change of the GUI screen 50 caused by the display of this pull-down menu and upon determination of the completion of the response because of detection of no change in the screen more than a fixed time period thereafter, instructs the screen analysis unit 103 to conduct an analysis of the screen.

Again, the screen analysis unit 103 analyzes the screen and outputs the analysis result as a web page of HTML, so that the web page is displayed on the screen of the terminal device 101.

FIG. 16 is a diagram showing one example of display, on the terminal device 101, of the information of the display screen shown in FIG. 15.

On the screen of FIG. 16, the names of the three sub-menu items 1500, “open”, “transmission” and “end” displayed in the pull-down menu of FIG. 15 are displayed as hyper-links.

Here, when the user selects the sub-menu item name 1500 of “transmission” as a hyper-link, the operation is similarly notified to the side of the computer 100, whereby the operation execution unit 106 executes the operation of clicking the sub-menu item 1500 “transmission” in the pull-down menu on the GUI screen 50 of FIG. 15.

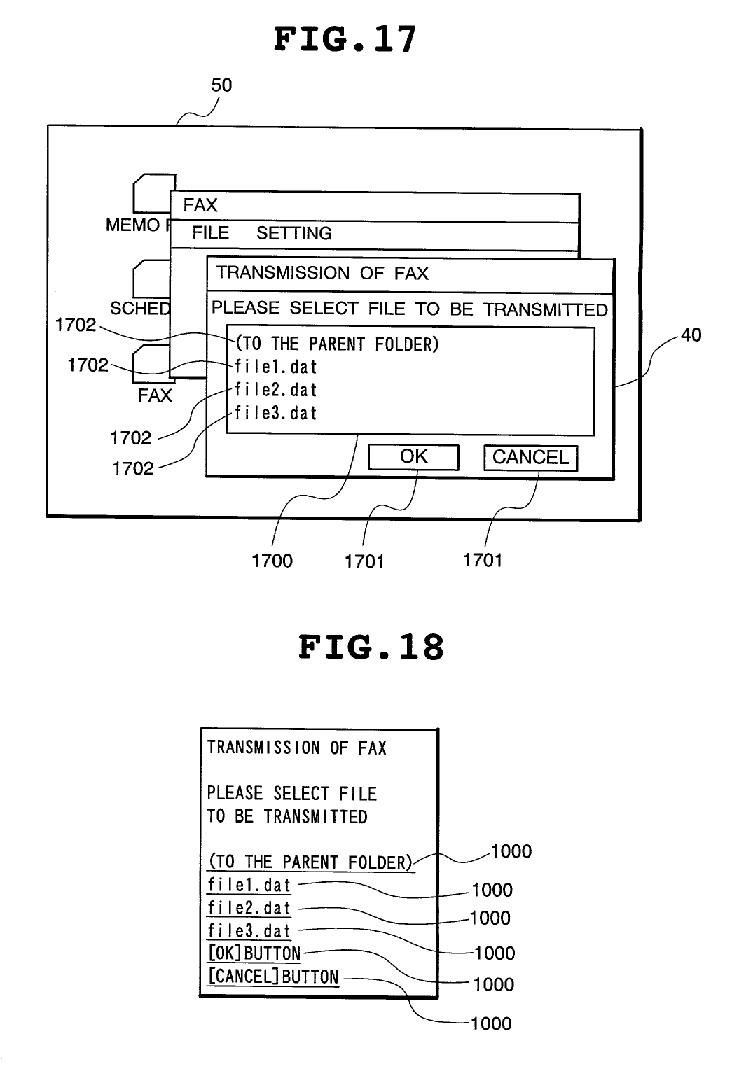

FIG. 17 is a diagram showing a state where the window 40 for Fax transmission is displayed by clicking the item of “transmission” on the screen of FIG. 15, in which the window 40 is currently an active window.

The “Fax transmission” window 40 has a list box 1700 for the selection of a file for use in transmission and buttons 1701 for giving instructions on the transmission and cancellation. In the list box 1700, a list of files 1702 to be transmitted which are recorded in a folder designated by the user is displayed.

In the same manner, the screen change detection unit 105 detects a screen change caused by the display of the “Fax transmission” window 40 and upon determination of the completion of the response because of detection of no change in the screen more than a fixed time period thereafter, instructs the screen analysis unit 103 to conduct an analysis of the screen.

Again, the screen analysis unit 103 analyzes the screen and outputs the analysis result as a web page of HTML, so that the web page is displayed on the screen of the terminal device 101.

FIG. 18 is a diagram showing one example of display, on the terminal device 101, of the information of the display screen shown in FIG. 17.

On the screen of FIG. 18, displayed as hyper-links are the file 1702 indicated at each item in the list box 1700 shown in FIG. 17 and “OK” and “cancel” of the buttons 1701.

Here, when the user selects “file2.dat” which is a hyper-link, the operation is similarly notified to the side of the computer 100, whereby the operation execution unit 106 executes the operation of clicking “file2.dat” of the file 1702 displayed in the list box 1700 on the GUI screen 50 of FIG. 17.

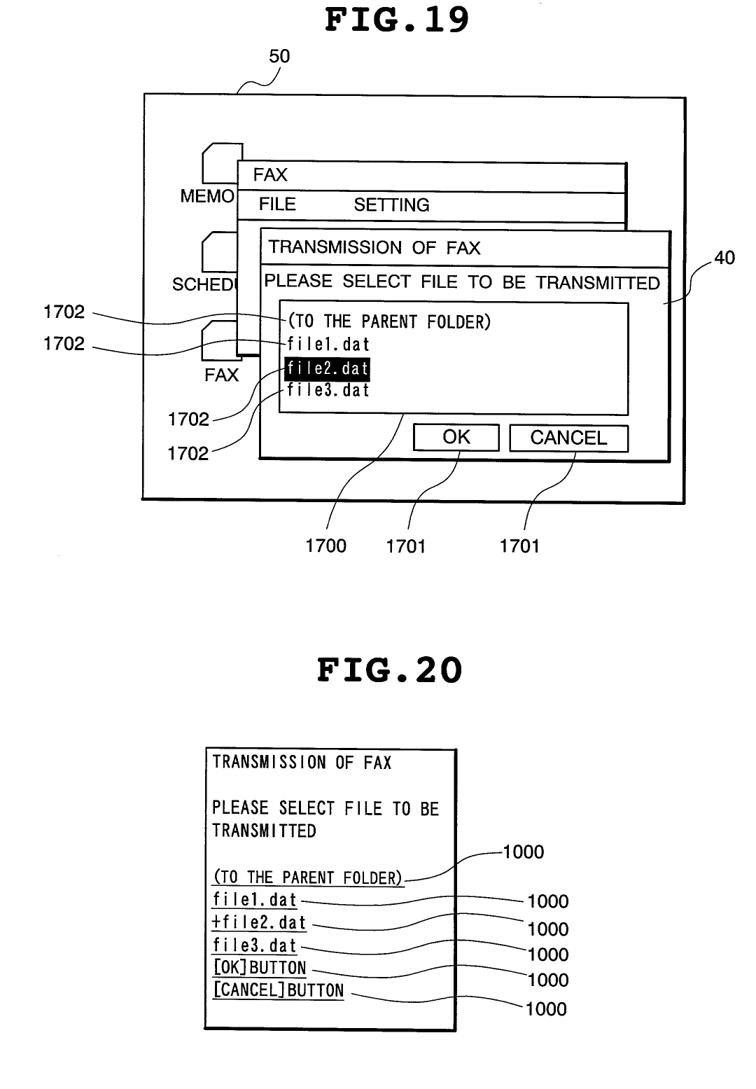

FIG. 19 is a diagram showing a state where “file2.dat” in the list box 1700 on the screen of FIG. 17 has its characters and color of the background inversely displayed as a result of its clicking to select the “file2. dat” file 1702.

In the same manner, the screen change detection unit 105 detects a screen change caused by inverted display of the item “file2.dat” in the list box 1700 and upon determination of the completion of the response because of detection of no change in the screen more than a fixed time period thereafter, instructs the screen analysis unit 103 to conduct an analysis of the screen.

Again, the screen analysis unit 103 analyzes the screen and outputs the analysis result as a web page of HTML, so that the web page is displayed on the screen of the terminal device 101.

FIG. 20 is a diagram showing one example of display of the information of the display screen shown in FIG. 19 on the terminal device 101.

On the screen of FIG. 20, the sign “+” attached to the head of a file name represents that the file in question is an item currently selected. In other words, in the present embodiment, the screen analysis unit 103 outputs a web page of the HTML format with the sign “+” attached to the head of a hyper-link of an item currently selected in the list box.

Here, when the user selects the hyper-link 1000 indicative of the “OK” button, the operation is similarly notified to the side of the computer 100, whereby the operation execution unit 106 executes the operation of clicking the “OK” button 1701 of the “Fax transmission” window 40 on the GUI screen 50 shown in FIG. 19.

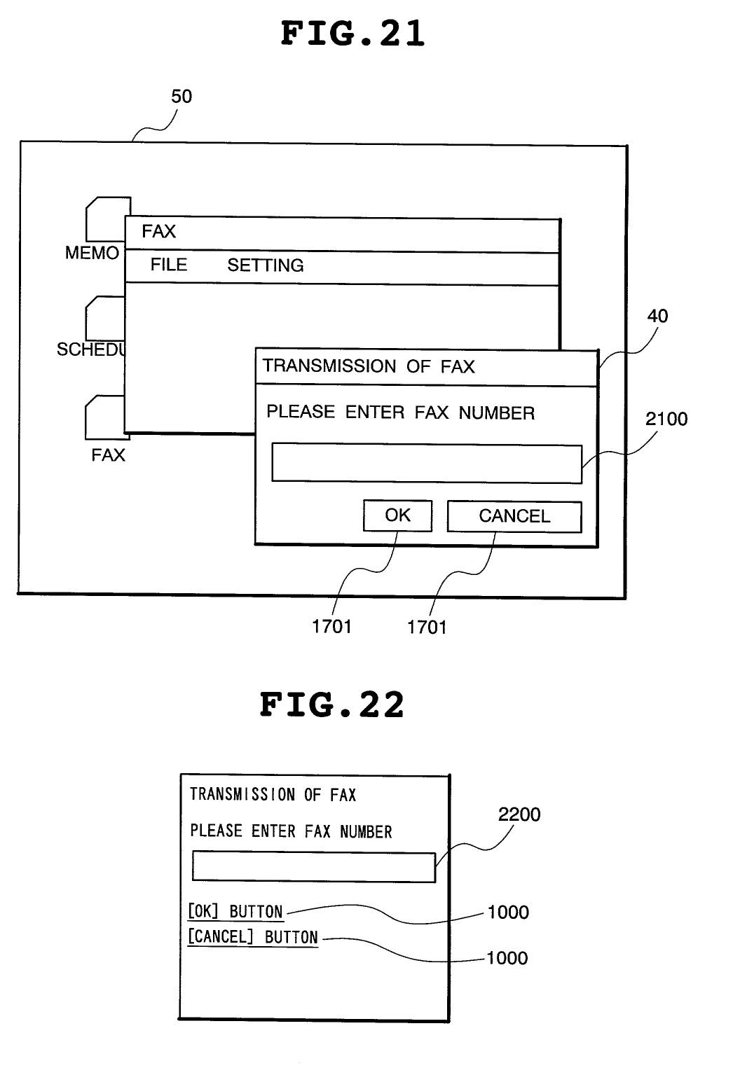

FIG. 21 is a diagram showing a state where the window 40 for the entry of a Fax number as the number of a Fax transmission destination is displayed by clicking the “OK” button 1701 on the screen of FIG. 19, in which the window 40 is currently an active window.

The window 40 for the entry of a Fax number has an entry box 2100 for the entry of a Fax number and buttons 1701, “OK” and “cancel”.

In the same manner, the screen change detection unit 105 detects a screen change caused by the display of the window 40 for the entry of a Fax number and upon determination of the completion of the response because of detection of no change in the screen more than a fixed time period thereafter, instructs the screen analysis unit 103 to conduct an analysis of the screen.

Again, the screen analysis unit 103 analyzes the screen and outputs the analysis result as a web page of HTML, so that the web page is displayed on the screen of the terminal device 101.

FIG. 22 is a diagram showing one example of display, on the terminal device 101, of the information of the display screen shown in FIG. 21.

In FIG. 22, a character string entry box 2200 is displayed corresponding to the character string entry box 2100 of FIG. 21. More specifically, in the present embodiment, when the character string entry box 2100 appears in an active window on the GUI screen 50 of the computer 100, the screen analysis unit 103 outputs a web page of the HTML format so as to display the character string entry box 2200 corresponding to the box 2100 on the screen of the terminal device 101. Since recent cellular phone terminals, PHS terminals, etc. ordinarily have a function of displaying the character string entry box 2200 on a web browser screen for the entry of characters, the present embodiment makes the use of this function to display the character string entry box 2200.

Here, when the user inputs the Fax number into the character string entry box 2200 and selects the hyper-link 1000 indicative of the “OK” button, the operation is similarly notified to the side of the computer 100, whereby the operation execution unit 106 inputs the Fax number entered by the user into the character string entry box 2100 on the GUI screen 50 of FIG. 21 and further clicks the “OK” button 1701 on the window 40 in question.

As a result, the computer 100 accepts the remote operation for giving an instruction on Fax transmission from the user to transmit the contents of the file “file2.dat” to the transmission destination having the designated Fax number.

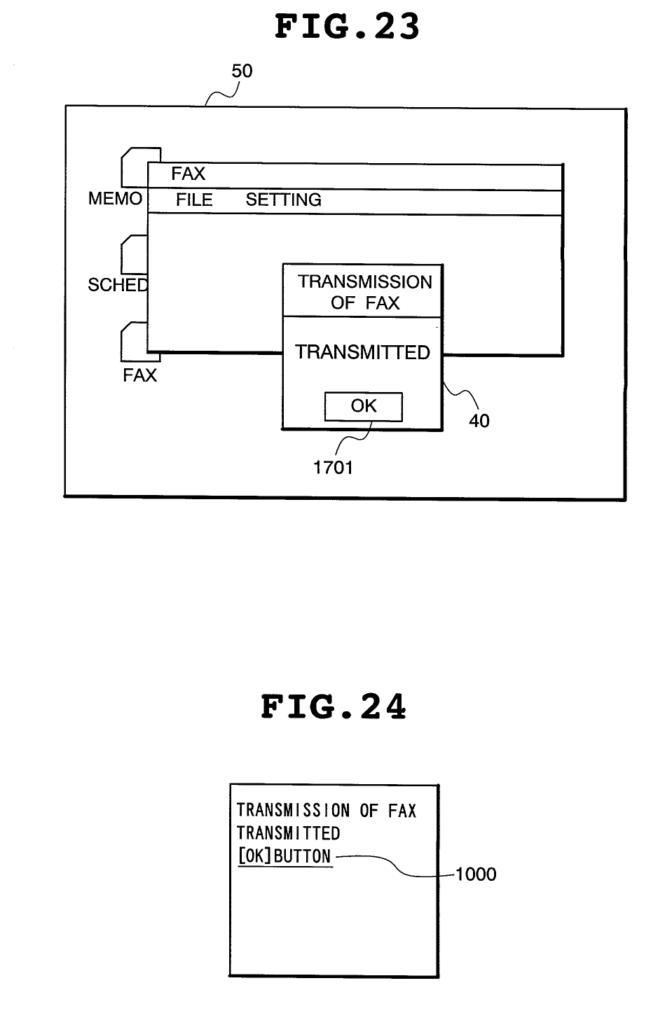

FIG. 23 is a diagram showing a state where in response to the entry of the Fax number and the instruction on transmission thereof on the screen of FIG. 21, the window 40 indicative of the completion of the transmission is displayed, in which the window 40 is currently an active window.

In the same manner, the screen change detection unit 105 detects a screen change caused by the display of the window 40 for the entry of the Fax number and upon determination of the completion of the response because of detection of no change in the screen more than a fixed time period thereafter, instructs the screen analysis unit 103 to conduct an analysis of the screen.

Again, the screen analysis unit 103 analyzes the screen and outputs the analysis result as a web page of HTML, so that the web page is displayed on the screen of the terminal device 101.

FIG. 24 is a diagram showing one example of display, on the terminal device 101, of the information of the display screen shown in FIG. 23.

Then, when the user executes the operation for closing the window 40 which notifies the completion of Fax transmission (FIG. 23) by selecting the hyper-link 1000 indicative of the “OK” button, the operation execution unit 106 clicks the “OK” button 1701 on the window 40 on the GUI screen of the computer 100. The window 40 notifying the completion of the Fax transmission is responsively closed to return the GUI screen 50 of the computer 100 to the state shown in FIG. 13.

By the foregoing procedure, a series of operation of transmitting facsimile by remotely operating the computer 100 is completed.

Next, a remote operation system of a second embodiment of the present invention will be described.

In the first embodiment, it is known in advance that the terminal device 101 is a terminal device capable of displaying a web page of the HTML format, and data of screen information output by the screen analysis unit 103 to the screen information transmission unit 104 is a web page of the HTML format. On the other hand, in the second embodiment, it is known in advance that the terminal device 101 is a terminal device capable of transmitting and receiving electronic mail, and data of screen information output by the screen analysis unit 103 to the screen information transmission unit 104 is a text of electronic mail.

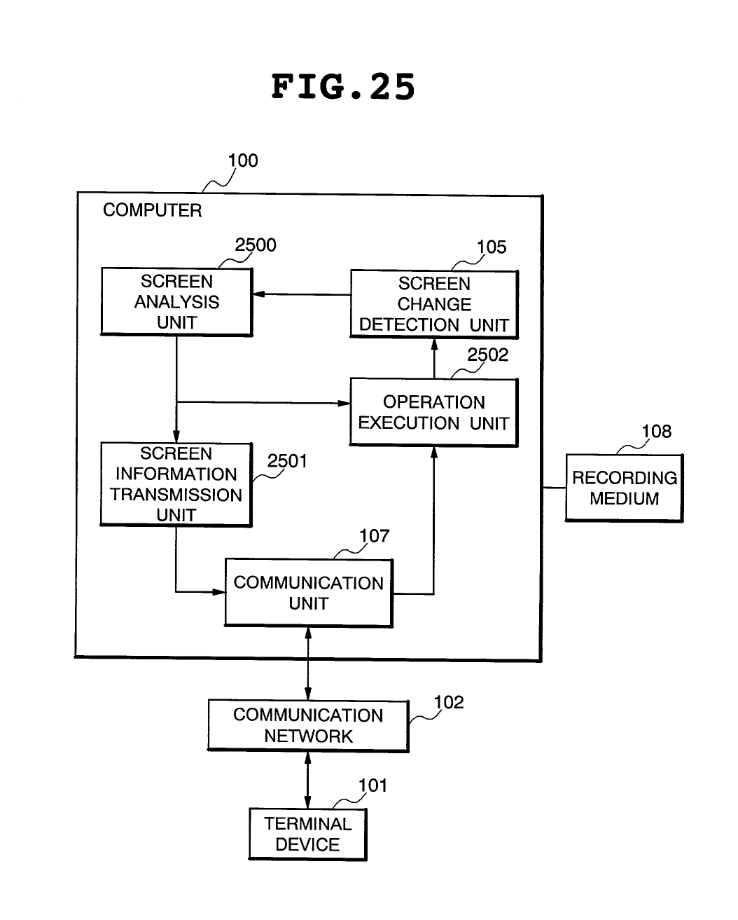

FIG. 25 is a block diagram showing a structure of a remote operation system according to the second embodiment. The remote operation system of the second embodiment is completely the same in basic operation as the remote operation system of the first embodiment and is different only in that data for remote operation is transmitted and received not as a web page of HTML sentences but as electronic mail.

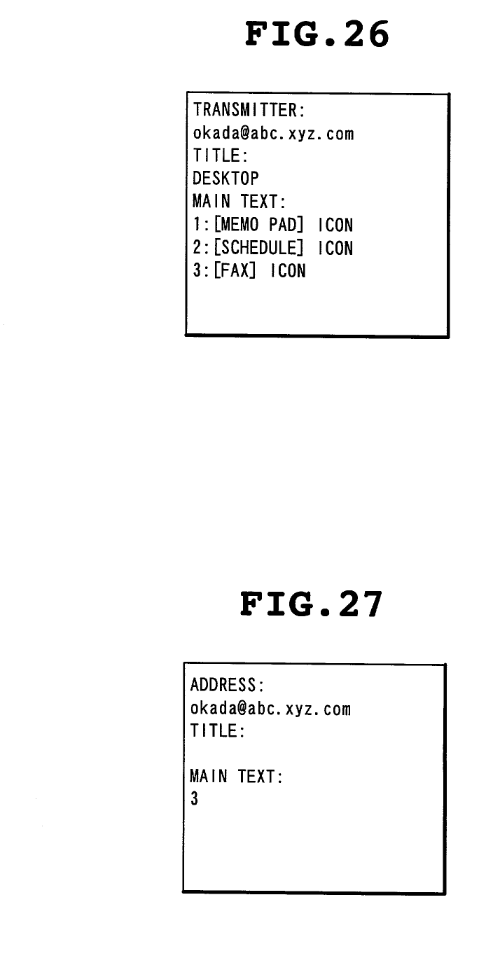

In a case where a display screen of the computer 100 is the display screen 50 shown in FIG. 11, for example, in the remote operation system of the second embodiment, a screen analysis unit 2500 analyzes the contents of the display screen 50 shown in FIG. 11 and outputs the result of the analysis as a text of electronic mail. A screen information transmission unit 2501 transmits the text of electronic mail to an electronic mail address of the terminal device 101. The terminal device 101 receives the electronic mail, which is displayed on the screen, for example, as shown in FIG. 26.

When a user looks at the screen of the electronic mail and wants to operate a “Fax” icon, for example, he or she will return such mail as shown in FIG. 27 in response to the received electronic mail having the screen shown in FIG. 26. In other words, he or she returns the mail with the number of an item to be operated entered into a column of a main text.

When the electronic mail is thus returned from the terminal device, an operation execution unit 2502 receives the returned electronic mail and analyzes the column of the main text of the returned electronic mail to determine operation to be conducted, and executes the operation in the same manner as in the first embodiment (in a case of the example of the electronic mail shown in FIG. 27, to double-click coordinates on the “Fax” icon 1100 in FIG. 11). As a result, the display screen of the computer 100 will be changed into the display screen 50 shown in FIG. 13.

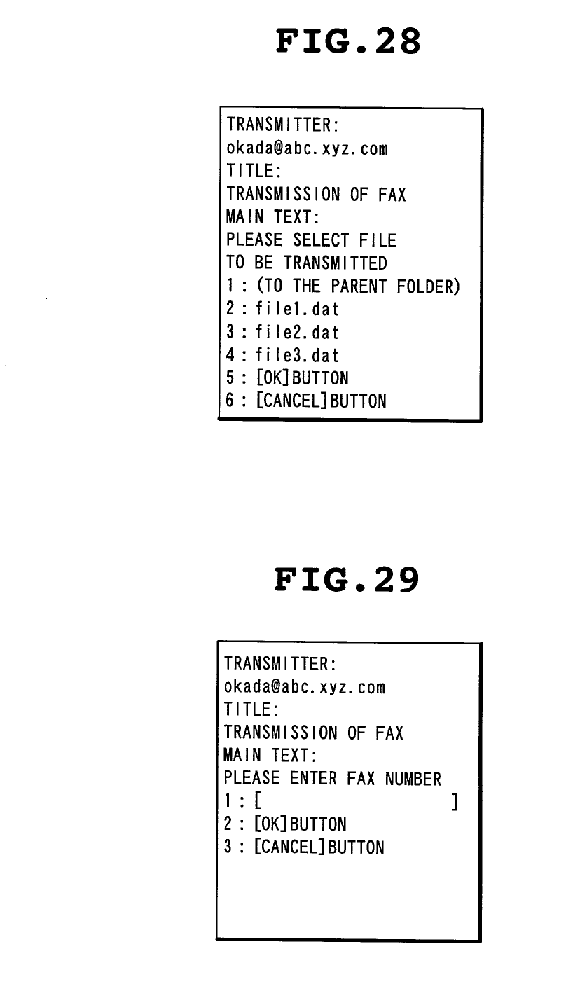

In a case where a display screen of the computer 100 is the display screen 50 shown in FIG. 17, for example, in the remote operation system of the second embodiment, the screen analysis unit 2500 analyzes the contents of the display screen 50 shown in FIG. 17 and outputs the result of the analysis as a text of electronic mail. The screen information transmission unit 2501 transmits the text of electronic mail to an electronic mail address of the terminal device 101. The terminal device 101 receives the electronic mail, which is displayed on the screen, for example, as shown in FIG. 28. When the user looks at the screen of the electronic mail and wants to select the “file2.dat” file, for example, he or she returns the same mail as that shown in FIG. 27 in response to the received electronic mail having the screen shown in FIG. 28.

When the operation execution unit 2502 receives the returned electronic mail, the unit 2502 executes operation of clicking “file2.dat” of the file 1702 displayed within the list box 1700 on the GUI screen 50 of FIG. 17. As a result, the display screen of the computer 100 will be changed into the display screen 50 shown in FIG. 19.

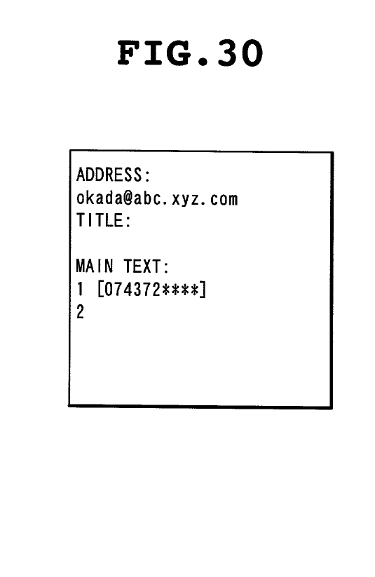

In a case where a display screen of the computer 100 is the display screen 50 shown in FIG. 21, for example, in the remote operation system of the second embodiment, the screen analysis unit 2500 analyzes the contents of the display screen 50 shown in FIG. 21 and outputs the result of the analysis as a text of electronic mail. The screen information transmission unit 2501 transmits the text of electronic mail to an electronic mail address of the terminal device 101. The terminal device 101 receives the electronic mail, which is displayed on the screen, for example, as shown in FIG. 29. When the user looks at the screen of the electronic mail and wants to enter a Fax number and select the “OK” button, he or she returns such mail as shown in FIG. 30 in response to the received electronic mail having the screen shown in FIG. 29.

Upon receiving the returned electronic mail, the operation execution unit 2502 enters the Fax number put in 1 of the main text of the received electronic mail shown in FIG. 30 into the character string entry box 2100 on the GUI screen 50 of FIG. 21 and further clicks the “OK” button 1701 on the window 40. As a result, the display screen of the computer 100 will be changed into the display screen 50 shown in FIG. 23. The foregoing described remote operation system of the second embodiment enables small-sized portable communication terminals such as a cellular phone and a PHS to conduct remote operation of an external computer while referring to the contents of a display screen of the computer. The system also enables remote operation of an external computer by freely using a portable communication terminal or the like at a user's hand without requiring a terminal on the side of conducting remote operation to have a special function for remote operation.

Next, a remote operation system according to a third embodiment of the present invention will be described.

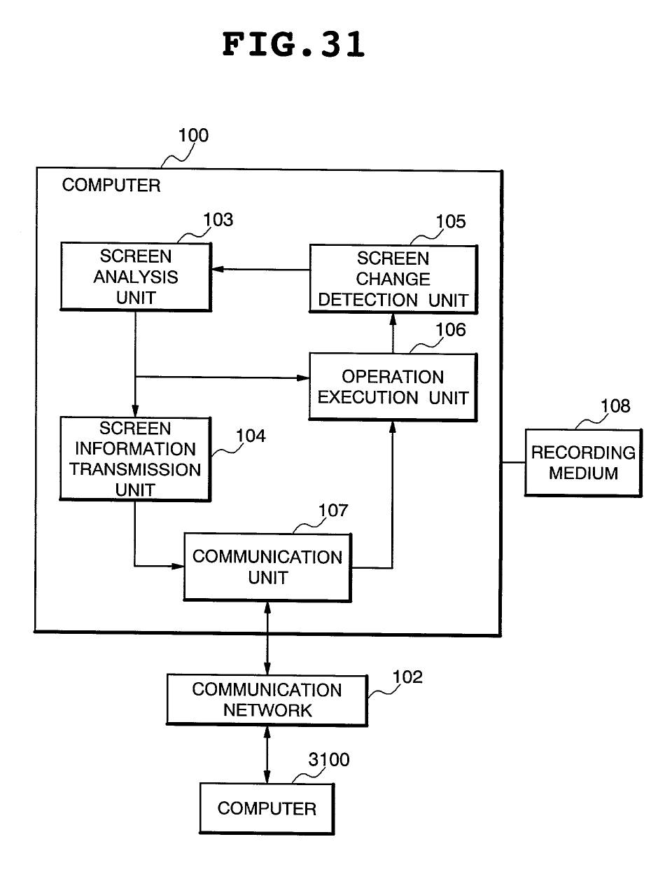

FIG. 31 is a block diagram showing a structure of the remote operation system according to the present embodiment.

Although the above-described remote operation systems of the first and second embodiments have been described assuming that a terminal on the side of conducting operation is such a terminal as a cellular phone or a PHS, the terminal is not limited thereto as long as it is such a terminal having a function of transmitting and receiving character data as a web browser. In the present embodiment shown in FIG. 31, used as the terminal on the side of conducting operation is a computer 3100 which is a personal computer, a notesized personal computer, or other information processing device.

The computer 3100, which is mounted with a Web browser, is capable of displaying data of the HTML format on a screen and also capable of displaying a GUI screen similarly to the computer 100 to be operated.

Since the remote operation system of the present embodiment is allowed to conduct remote operation using only a web browser etc., it requires a terminal on the side of conducting operation to be provided with none of special software, a semiconductor circuit or the like for remote operation unlike conventional remote operation systems.

Most of recent personal computers and note-sized personal computers are marketed with a web browser mounted thereon in advance. Therefore, these terminals can be used as the computer 3100 of the present embodiment without additionally providing special software.

Operation of the remote operation system according to the present embodiment is the same as that of the first embodiment. Data having the HTML format of screen information output by the screen analysis unit 103 is displayed on the screen of the computer 3100 and the operation execution unit 106 executes operation of the computer 100 according to operation executed on the computer 3100.

The above-described remote operation system of the present embodiment attains the same effects as obtained by the first embodiment also in a case where a computer is used as a terminal on the side of conducting operation.

Moreover, unlike a conventional remote operation system using a GUI in which a computer is used as a terminal on the side of conducting operation, the system of the present embodiment enables drastic reduction of communication costs because it is capable of conducting remote operation by transmitting only the minimum necessary data indicative of information of a screen of a computer to be operated.

In addition, in such a system having a terminal on the side of conducting operation provided with an image data displaying function as the present embodiment, a function may be provided of transmitting image data of the whole or a designated part (within a window of an application or the like) of a GUI screen of the computer 100 to be operated to the user's computer 3100 based on the user's instruction or predetermined setting. This enables detailed display contents of a GUI screen, which are unclear only with character data, to be displayed in a web browser of the user's computer 3100 or the like for confirmation.

Next, a remote operation system according to a fourth embodiment of the present invention will be described.

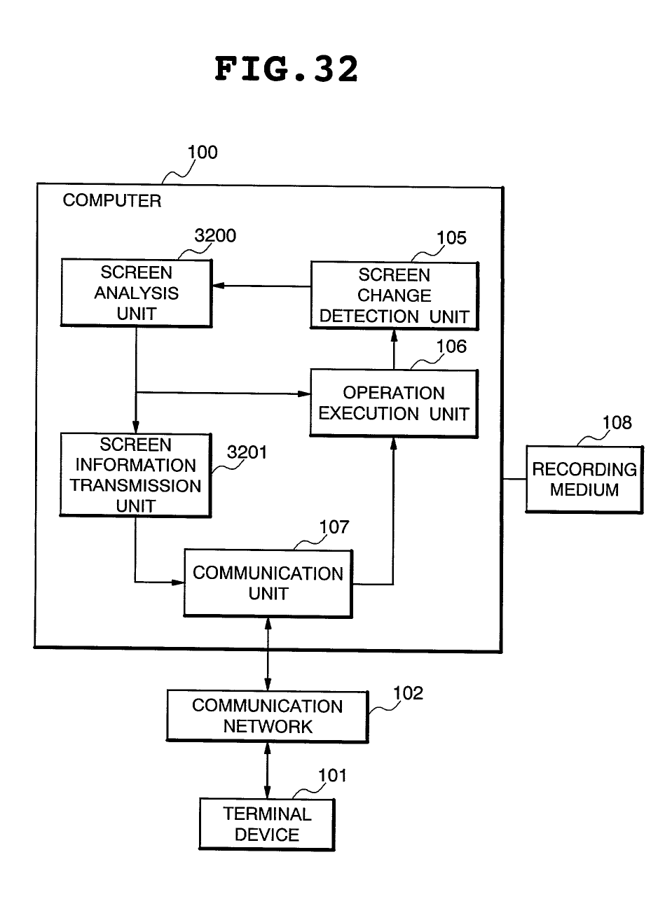

FIG. 32 is a block diagram showing a structure of the remote operation system according to the fourth embodiment. The remote operation system of the fourth embodiment is completely the same as the remote operation system of the first embodiment in basic operation and is different only in operation of a screen analysis unit 3200 and a screen information transmission unit 3201. In the remote operation system according to the fourth embodiment, when still picture or moving picture is displayed within an active window displayed on a current GUI screen of the computer 100, the screen analysis unit 3200 detects the picture. When detecting still picture or moving picture being displayed, the screen analysis unit 3200 furthermore extracts display data of the still picture or the moving picture and outputs the data to the screen information transmission unit 3201 together with data of a web page in the HTML format. The screen information transmission unit 3201 transmits the data received from the screen analysis unit 3200 to the terminal device 101.

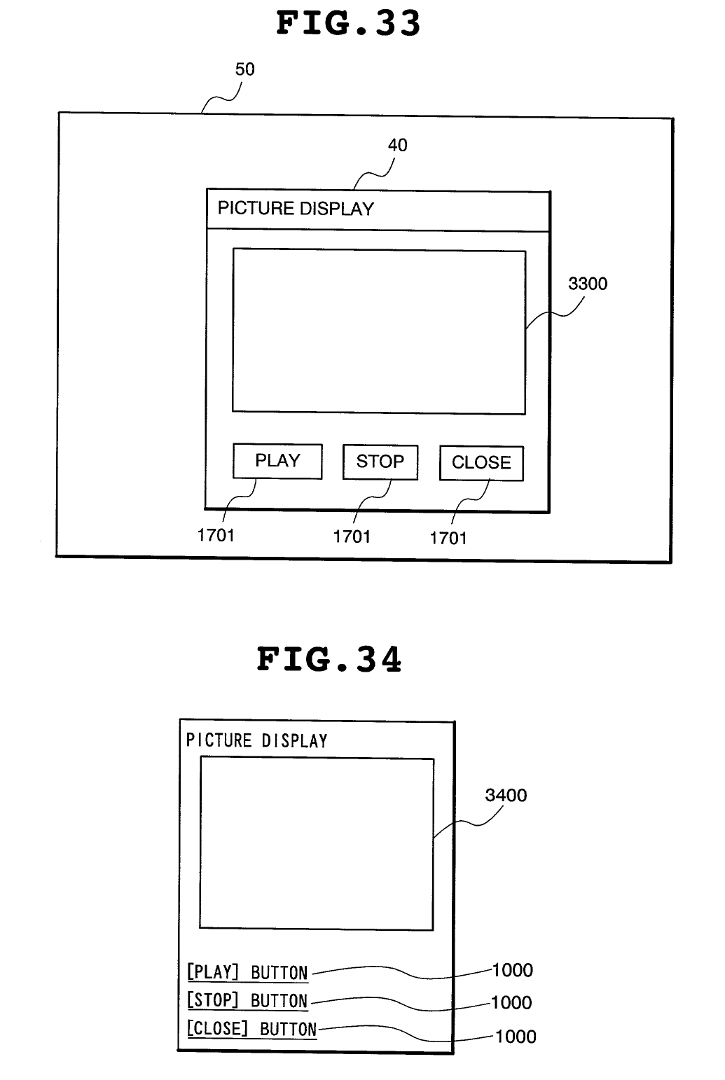

Assume, for example, that the current screen of the computer 100 is the same as the screen 50 of FIG. 33. It is also assumed that the picture display window 40 is currently an active window and in a picture display box 3300 on the picture display window 40, still picture such as a photograph or moving picture such as TV is displayed. In this case, the screen analysis unit 3200 detects the picture display window 40 being currently the active window and analyzes information of GUI widgets on the window to output data of a web page in the HTML format, as well as detecting the picture display box 3300 in which still picture or moving picture is displayed existing on the window 40 to extract and output picture data displayed in the picture display box 3300.

These pieces of data output by the screen analysis unit 3200 are transmitted to the terminal device 101 by the screen information transmission unit 3201 and as a result, these pieces of data are displayed on the screen of the terminal device 101 as shown in FIG. 34. The picture data displayed in the picture display box 3300 of FIG. 33 is displayed in a picture display box 3400 shown in FIG. 34. When the picture displayed in the picture display box 3300 is moving picture, the picture in the picture display box 3300 changes with time, according to which change, the picture in the picture display box 3400 also changes. In other words, when detecting moving display, the screen analysis unit 3200 continuously extracts data of picture in the picture display box 3300 in which moving picture is displayed and continuously outputs the data to the screen information transmission unit 3201. The screen information transmission unit 3201 continuously transmits picture data of this moving picture to the picture display box 3400. In the present embodiment, the terminal device 101 is a terminal device capable of displaying the picture display box 3400 and also capable of displaying still picture or moving picture in the picture display box 3400.

Next, a remote operation system according to a fifth embodiment of the present invention will be described.

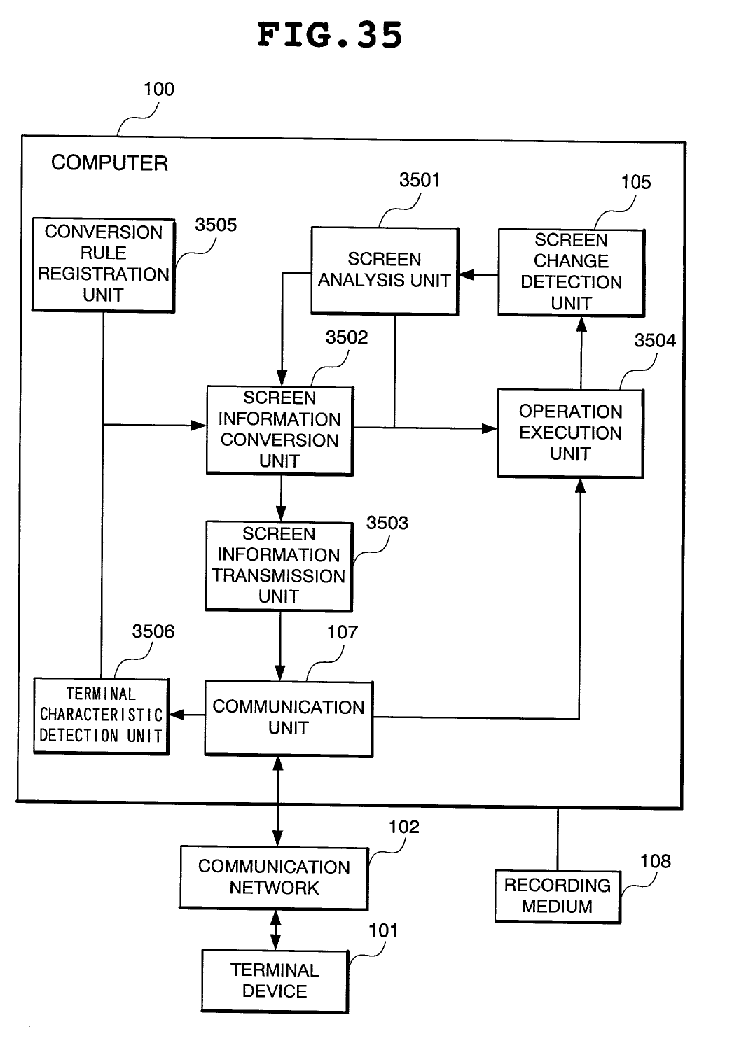

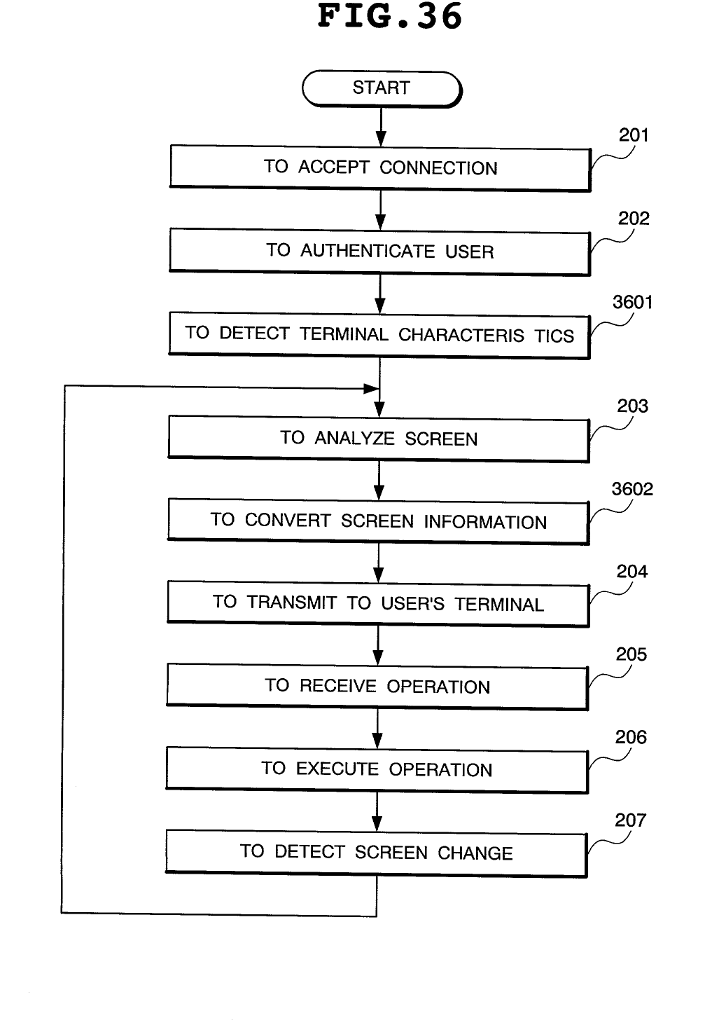

FIG. 35 is a block diagram showing a structure of the remote operation system according to the fifth embodiment. With reference to FIG. 35, the remote operation system according to the fifth embodiment includes, in addition to the components of the remote operation system according to the first embodiment shown in FIG. 1, a screen information conversion unit 3502, a conversion rule registration unit 3505 and a terminal characteristic detection unit 3506.

The terminal characteristic detection unit 3506 detects terminal characteristics of the terminal device 101. Terminal characteristics are an ID inherent to a terminal device, a type of machine, a processing rate, a communication rate, a communication cost per unit volume of data, a communication cost per unit time, a data format that can be displayed on a screen, a playable sound data format, executable program and script formats, a volume of data receivable at one time, a color that can be displayed, a character font that can be displayed, a screen resolution, physical lengths of a screen in vertical and lateral directions, the number of characters that can be displayed in the vertical and lateral directions in one screen, and the like.

The screen information conversion unit 3502 converts data of a result of a screen analysis obtained by the screen analysis unit 3501 into data suitable for transmission to the terminal device 101 or display at the terminal device 101 taking terminal characteristics of the terminal device 101 detected by the terminal characteristic detection unit 3506 into consideration. Rules for the conversion are registered at the conversion rule registration unit 3505.

FIG. 36 is a flow chart for use in explaining processing of remote operation by the fifth embodiment of the present invention.

With reference to FIG. 36, the processing of the remote operation system according to the fifth embodiment is the same as that of the remote operation system according to the first embodiment up to authentication of a user (Step 202).

Upon completion of the authentication of a user, the terminal characteristic detection unit 3506 detects characteristics of the terminal device 101 (Step 3601). Next, the screen analysis unit 3501 analyzes the current screen of the computer 3500 (Step 203, the same as that of the first embodiment). Then, the screen information conversion unit 3502 converts data of a result of the screen analysis obtained by the screen analysis unit 3501 (Step 3602). The converted data is transmitted to the terminal device 101 by the screen information transmission unit 3503 and displayed on the screen of the user's terminal 101 (Step 204).

Then, when the user executes operation for the computer 3500 by using the terminal device 101, the operation execution unit 3504 receives information of the operation and executes the operation on the computer 3500 (Steps 205 and 206).

When display of the screen of the computer 3500 is changed by this operation, the screen change detection unit 105 detects the change. Upon finding that the change is completed, again execute the processing at Step 203 and the following steps to update data displayed on the screen of the user's terminal device 101 to be the latest one.

Next, one specific example of remote operation by the remote operation system according to the fifth embodiment will be described.

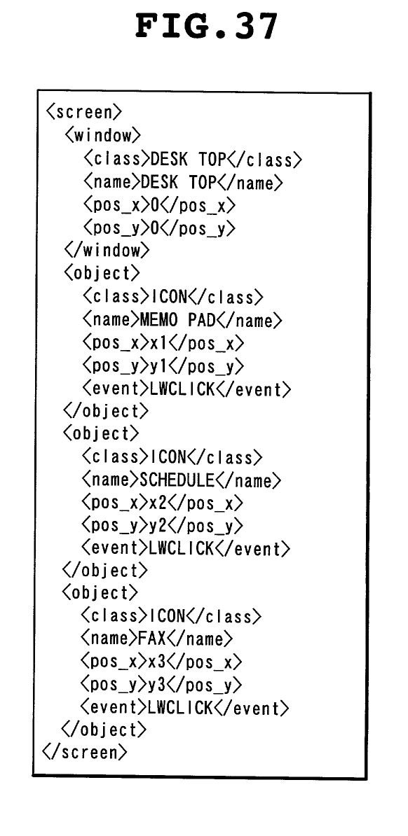

The screen analysis unit 3501 analyzes the display screen of the computer 3500 and outputs data of an analysis result in a general-purpose format independent of device characteristics of the terminal device 101, for example, the XML (extensible markup language) format. Assume, for example, that one example of the display screen 50 of the computer 3500 is as shown in FIG. 11 similarly to the case of the one specific example of the remote operation in the first embodiment. FIG. 37 shows one example of data of screen information of the XML format obtained by an analysis of the display screen 50 shown in FIG. 11 by the screen analysis unit 3501 and output to the screen information conversion unit 3052. In FIG. 37, x1 to x3 and y1 to y3 are values of an x coordinate and a y coordinate of the three icons 1100 shown in FIG. 11. In FIG. 37, event tag represents an operation event, while LWCLICK represents double-click by a left button of the mouse.

In this example, the device characteristic detection unit 3506 detects an ID inherent to the terminal device 101, and registered in the conversion result registration unit 3505 for each ID inherent to the terminal device 101 are rules for converting data of a general-purpose format output by the screen analysis unit 3501 into data of a format suitable for the terminal device having the inherent ID in question. Assume, for example, that an inherent ID of the terminal device 101 is detected being Z and that rules for converting data of screen information from the XML format to the HTML format in a case of a terminal device whose inherent ID is Z are registered at the conversion rule registration unit 3505 (that is, in this case, the terminal device 101 whose inherent ID is Z is a terminal device capable of displaying data of the HTML format). In this case, the screen information conversion unit 3502 converts the data of the screen information having the XML format output by the screen analysis unit 3501 into data of the HTML format according to the conversion rules for a terminal device whose inherent ID is Z which are registered at the conversion rule registration unit 3505. The data of the HTML format is transmitted to the terminal device 101 by the screen information transmission unit 3503 and displayed on the screen of the terminal device 101 similarly to the example of FIG. 12.

The operation execution unit 3504 receives information of the operation conducted on the terminal device 101 and executes operation corresponding to the operation on the computer 3500. Assume that operation conducted at the terminal device 101 is V, operation to be conducted on the computer 3500 corresponding to V can be specified based on information correlating the data of the screen information output by the screen analysis unit 3501 and the data obtained by converting the format of the data of the screen information in question by the screen information conversion unit 3502 (information about which parts of the data before conversion and the data after the conversion correspond to each other).

In another example, the device characteristic detection unit 3506 detects a kind of machine of the terminal device 101, and registered in the conversion rule registration unit 3505 for each kind of the terminal device 101 are rules for converting data of a general-purpose format output by the screen analysis unit 3501 into data of a format suitable for the kind of machine in question. Assume, for example, that a kind of the terminal device 101 is detected being Z and that rules for converting data of screen information from the XML format to a mail format in a case of a terminal device whose kind is Z are registered at the conversion rule registration unit 3505 (that is, in this case, the terminal device 101 whose kind of machine is Z is a terminal device capable of transmitting and receiving mail). In this case, the screen information conversion unit 3502 converts the data of the screen information having the XML format output by the screen analysis unit 3501 into data of the mail format according to the conversion rules for a terminal device of Z kind registered at the conversion rule registration unit 3505. The data of the mail format is transmitted as mail to the terminal device 101 by the screen information transmission unit 3503 and displayed on the screen of the terminal device 101 similarly to the example shown in FIG. 26.

In a further example, the device characteristic detection unit 3506 detects a processing rate of the terminal device 101, and registered in the conversion rule registration unit 3505 are rules for converting data of a general-purpose format output by the screen analysis unit 3501 according to the processing rate of the terminal device 101. Assume, for example, that a processing rate of the terminal device 101 is detected being Z1 and that registered at the conversion rule registration unit 3505 are (1) rules for converting data of screen information from the XML format to the HTML format and (2) rules for deleting part of the screen information when the processing rate is less than Z2. In this case, according to the rules (1) and (2) registered at the conversion rule registration unit 3505, the screen information conversion unit 3502 converts the data of the screen information having the XML format output by the screen analysis unit 3501 into data of the HTML format after deleting a part of the data when Z1<Z2 and converts all the data of the screen information having the XML format output by the screen analysis unit 3501 into the HTML format when Z1=Z2 or Z1>Z2. As can be seen from the foregoing description, the present example reduces load on screen information displaying processing at the terminal device 101 by deleting part of screen information when the processing rate of the terminal device is low.

In a still further example, the device characteristic detection unit 3506 detects a communication rate of the terminal device 101, and registered in the conversion rule registration unit 3505 are rules for converting data of a general-purpose format output by the screen analysis unit 3501 according to the communication rate of the terminal device 101. Assume, for example, that the communication rate of the terminal device 101 is detected being Z1 and that registered at the conversion rule registration unit 3505 are (1) rules for converting data of screen information from the XML format to the HTML format and (2) rules for deleting part of the screen information when the communication rate is less than Z2. In this case, according to the conversion rules (1) and (2) registered at the conversion rule registration unit 3505, the screen information conversion unit 3502, similarly to the above case of processing rate detection, converts the data of the screen information having the XML format output by the screen analysis unit 3501 into data of the HTML format after deleting part of the data when Z1<Z2 and converts all the data of the screen information having the XML format output by the screen analysis unit 3501 into the HTML format when Z1=Z2 or Z1>Z2. As can be seen from the foregoing description, the present example reduces the volume of data transmission from the computer 3500 to the terminal device 101 by deleting part of screen information when the communication rate of the terminal device is low.

In a still further example, the device characteristic detection unit 3506 detects a communication cost of the terminal device 101 per unit volume of data, and registered in the conversion rule registration unit 3505 are rules for converting data of a general-purpose format output by the screen analysis unit 3501 according to a communication cost of the terminal device 101 per unit volume of data. Communication cost of the terminal device 101 per unit volume of data may be directly detectable or may be indirectly detectable from an inherent ID or a kind of machine of the terminal device 101. Assume, for example, that a communication cost of the terminal device 101 per unit volume of data is detected being Z1 and that registered at the conversion rule registration unit 3505 are (1) rules for converting data of screen information from the XML format to the HTML format and (2) rules for deleting part of the screen information when the communication cost per unit volume of data is not less than Z2. In this case, according to the conversion rules (1) and (2) registered at the conversion rule registration unit 3505, the screen information conversion unit 3502 converts the data of the screen information having the XML format output by the screen analysis unit 3501 into data of the HTML format after deleting part of the data when Z1=Z2 or Z1>Z2 and converts all the data of the screen information having the XML format output by the screen analysis unit 3501 into the HTML format when Z1<Z2. In other words, the present example reduces costs for data transmission from the computer 3500 to the terminal device 101 by deleting part of screen information when a communication cost of the terminal device 101 per unit volume of data is high.

In a still further example, the device characteristic detection unit 3506 detects a communication cost of the terminal device 101 per unit time, and registered in the conversion rule registration unit 3505 are rules for converting data of a general-purpose format output by the screen analysis unit 3501 according to a communication cost of the terminal device 101 per unit time. Communication cost of the terminal device 101 per unit time may be directly detectable or may be indirectly detectable from an inherent ID or a kind of machine of the terminal device 101 similarly to the above-described case of communication cost per unit volume of data. Assume, for example, that a communication cost of the terminal device 101 per unit time is detected being Z1 and that registered at the conversion rule registration unit 3505 are (1) rules for converting data of screen information from the XML format to the HTML format and (2) rules for deleting part of the screen information when the communication cost per unit time is not less than Z2. In this case, according to the conversion rules (1) and (2) registered at the conversion rule registration unit 3505, the screen information conversion unit 3502 converts the data of the screen information having the XML format output by the screen analysis unit 3501 into data of the HTML format after deleting part of the data when Z1=Z2 or Z1>Z2 and converts all the data of the screen information having the XML format output by the screen analysis unit 3501 into the HTML format when Z1<Z2. In other words, the present example reduces costs for data transmission from the computer 3500 to the terminal device 101 by deleting part of screen information when a communication cost of the terminal device 101 per unit time is high (because reduction in the volume of data communicated leads to reduction in a communication time).

In a still further example, the device characteristic detection unit 3506 detects a data format that can be displayed on the screen of the terminal device 101, and registered in the conversion rule registration unit 3505 are rules for converting data of a general-purpose format output by the screen analysis unit 3501 into data of a format that can be displayed on the screen of the terminal device 101. Data format that can be displayed on the screen of the terminal device 101 may be directly detectable or may be indirectly detectable from an inherent ID or a kind of machine of the terminal device 101 similarly to the above-described examples. Assume, for example, that a data format that can be displayed on the screen of the terminal device 101 is detected being the HTML format and that registered at the conversion rule registration unit 3505 are rules for converting data of screen information from the XML format to the HTML format and a plurality of rules for converting the data into other formats (mail format etc.) than the HTML format. In this case, according to the above-described conversion rules registered at the conversion rule registration unit 3505, the screen information conversion unit 3502 converts the data of the screen information having the XML format output by the screen analysis unit 3501 into data of the HTML format.

In a still further example, the device characteristic detection unit 3506 detects program and script formats executable at the terminal device 101, and registered in the conversion rule registration unit 3505 are rules for converting data of a general-purpose format output by the screen analysis unit 3501 into a program or a script whose format is executable on the terminal device 101. Formats of a program and a script executable at the terminal device 101 may be directly detectable or may be indirectly detectable from an inherent ID or a kind of machine of the terminal device 101 similarly to the above-described examples. Assume, for example, that a program of a Java format and a script of a Java script format are detected being executable at the terminal device 101 and that registered at the conversion rule registration unit 3505 are rules for converting data of screen information having the XML format into a script of the Java script format. In this case, according to the above-described conversion rules registered at the conversion rule registration unit 3505, the screen information conversion unit 3502 converts the data of the screen information having the XML format output by the screen analysis unit 3501 into a script of the Java script format. This processing is also the same in a case where rules for converting data of screen information having the XML format into a program of the Java format are registered in the conversion rule registration unit 3505.

In a still further example, the device characteristic detection unit 3506 detects a volume of data receivable at one time by the terminal device 101, and registered in the conversion rule registration unit 3505 are rules for converting a volume of data to be transmitted to the terminal device 101 into data whose volume is not more than the volume of data receivable by the terminal device 101 at one time. Volume of data receivable by the terminal device 101 at one time may be directly detectable or may be indirectly detectable from an inherent ID or a kind of machine of the terminal device 101 similarly to the above-described examples. Assume, for example, that a data format that can be displayed on the screen of the terminal device 101 is detected being the HTML format and the volume of data receivable at the terminal device 101 at one time is detected being Z and that registered at the conversion rule registration unit 3505 are (1) rules for converting data of screen information from the XML format to the HTML format and (2) rules for deleting part of the data of the HTML format such that the volume of data is not more than Z. In this case, according to the above-described conversion rules (1) and (2) registered at the conversion rule registration unit 3505, the screen information conversion unit 3502 converts the data of the screen information having the XML format output by the screen analysis unit 3501 into data of the HTML format and furthermore deletes part of the data having the HTML format such that the volume of data is not more than Z. In other words, since the terminal device 101 is capable of receiving a certain fixed volume of data at one time, reducing the volume of data of screen information to be transmitted down to not more than a limited volume enables even the terminal device 101 whose volume of receivable data is limited to display screen information of the computer 3500.

In a still further example, the device characteristic detection unit 3506 detects a color that can be displayed on the screen of the terminal device 101, and registered in the conversion rule registration unit 3505 are rules for converting data of a general-purpose format output by the screen analysis unit 3501 according to a color that can be displayed on the screen of the terminal device 101. Color that can be displayed on the screen of the terminal device 101 may be directly detectable or may be indirectly detectable from an inherent ID or a kind of machine of the terminal device 101 similarly to the above-described examples. Assume, for example, that a data format that can be displayed on the screen of the terminal device 101 is detected being the HTML format, that colors that can be displayed on the screen of the terminal device 101 are a total of 256 colors including black, red and blue and that registered at the conversion rule registration unit 3505 are (1) rules for converting data of screen information from the XML format to the HTML format and (2) rules for using a color designation tag of the HTML so as to express information of the same kind of GUI widgets (button, menu, etc.) by the same color and selecting the color from the colors that can be displayed on the screen of the portable terminal 101. In this case, according to the above-described conversion rules (1) and (2) registered at the conversion rule registration unit 3505, the screen information conversion unit 3502 converts the data of the screen information having the XML format output by the screen analysis unit 3501 into data having the HTML format and furthermore a color designation tag of the HTML is used so as to express information of the same kind of GUI widgets by the same color in the conversion to the HTML and the color to be used is selected from among the colors that can be displayed on the screen of the terminal device 101. Also in a case where the device characteristic detection unit 3506 detects a character font that can be displayed on the screen of the terminal device 101, a character font that can be displayed is detected and data of screen information is converted such that the data is displayed on the screen of the portable terminal 101 using the detected character font in completely the same manner as that of the above-described case of the color.

In a still further example, the device characteristic detection unit 3506 detects a screen resolution of the terminal device 101, and registered in the conversion rule registration unit 3505 are rules for converting data of a general-purpose format output by the screen analysis unit 3501 according to the screen resolution of the terminal device 101. Assume, for example, that a data format that can be displayed on the screen of the terminal device 101 is detected being the HTML format, that a screen resolution of the terminal device 101 is detected being W1 pixels in the lateral direction and H1 pixels in the vertical direction and that registered at the conversion rule registration unit 3505 are (1) rules for converting data of screen information from the XML format to the HTML format and (2) rules for deleting part of the screen information when the screen resolution is less than W2 pixels in the lateral direction and less than H2 pixels in the vertical direction. In this case, according to the conversion rules (1) and (2) registered at the conversion rule registration unit 3505, the screen information conversion unit 3502 converts the data of the screen information having the XML format output by the screen analysis unit 3501 into data of the HTML format after deleting part of the data when W1<W2 and H1<H2 and otherwise, converts all the data of the screen information having the XML format output by the screen analysis unit 3501 into data of the HTML format. In other words, when a screen resolution of the terminal device 101 is smaller than a fixed size, the present example suppresses the amount of information displayed on a terminal device whose screen size is small by deleting part of screen information. Also in a case where the device characteristic detection unit 3506 detects physical lengths in the vertical and lateral directions of the screen of the terminal device 101 or the number of characters that can be displayed in the vertical and lateral directions within one screen, data of screen information is converted with part of them deleted when a physical length of a screen in the vertical and lateral directions are smaller than fixed values or when the number of characters that can be displayed in the vertical and lateral directions within one screen is smaller than fixed values in completely the same manner as the above-described case of screen resolution.

Next, a remote operation system according to a sixth embodiment of the present invention will be described.

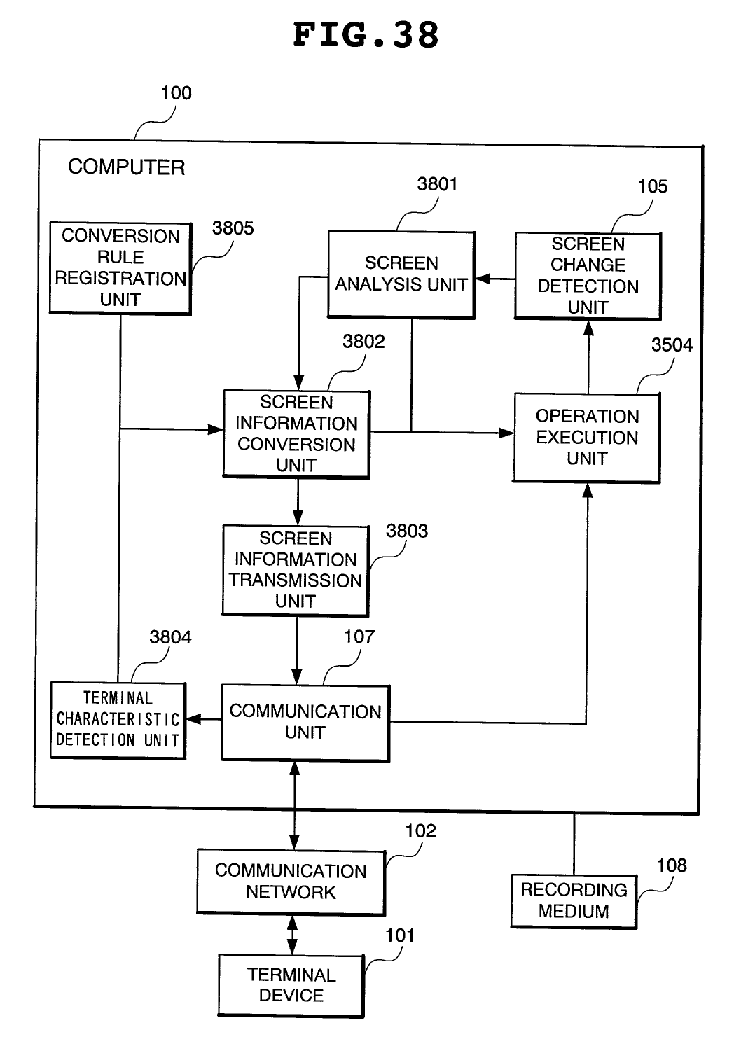

FIG. 38 is a block diagram showing a structure of the remote operation system according to the sixth embodiment. The remote operation system of the sixth embodiment is completely the same as the remote operation system of the fifth embodiment in basic operation with the only difference in operation of a screen analysis unit 3801, a screen information conversion unit 3802, a screen information transmission unit 3803, a terminal characteristic detection unit 3804 and a conversion rule registration unit 3805.

In the remote operation system of the sixth embodiment, the screen analysis unit 3801 detects still picture or moving picture being displayed, if it is displayed, within an active window displayed on the current GUI screen of the computer 100. When detecting still picture or moving picture being displayed, the screen analysis unit 3801 furthermore extracts display data of the still picture or the moving picture and outputs the data together with data of screen information of the XML format to the screen information conversion unit 3802.

In addition, the terminal characteristic detection unit 3804 is capable of detecting a data format of still picture and moving picture that can be displayed on the terminal device 101, and in the conversion rule registration unit 3805, rules are registered for converting display data of still picture or moving picture extracted by the screen analysis unit into data of the still picture or the moving picture having a format that can be displayed on the terminal device 101.

In addition to converting data of screen information of the XML format into data of a format that can be displayed on the terminal device 101 similarly to the case of the fifth embodiment, the screen information conversion unit 3802 converts display data of still picture or moving picture extracted by the screen analysis unit 3801 into data of still picture or moving picture having a format that can be displayed at the terminal device 101 according to the rules registered at the conversion rule registration unit 3805. These pieces of data are transmitted to the terminal device 101 by the screen information transmission unit 3803 and displayed on the screen of the terminal device 101.

Assume, for example, that the current screen of the computer 100 is the same as the screen 50 of FIG. 33, on which it is assumed that the picture display window 40 is currently an active window and in the picture display box 3300 on the picture display window 40, still picture such as a photograph or moving picture such as TV is displayed. In this case, the screen analysis unit 3801 detects the picture display window 40 being currently an active window and analyzes information of GUI widgets on the window to output data of the screen information in the XML format, as well as detecting the picture display box 3300 in which still picture or moving picture is displayed existing on the window 40 and extracting and outputting picture data displayed in the picture display box 3300.

The data of the screen information in the XML format and the picture data output by the screen analysis unit 3801 are converted into data whose format can be displayed on the terminal device 101 by the screen information conversion unit 3802 and transmitted to the terminal device 101 by the screen information transmission unit 3803. As a result, the data is displayed on the screen of the terminal device 101 as shown in FIG. 34. The picture data displayed in the picture display box 3400 of FIG. 34 is data obtained by converting the picture data of the picture display box 3300 shown in FIG. 33. When picture displayed in the picture display box 3300 is moving picture, picture in the picture display box 3300 changes with time, according to which change picture in the picture display box 3400 also changes. In other words, when the screen analysis unit 3801 detects moving picture display, the screen analysis unit 3801 continuously extracts data of picture in the picture display box 3300 in which the moving picture is displayed and continuously outputs the data to the screen information conversion unit 3802. The screen information conversion unit 3802 continuously converts picture data of the moving picture and furthermore the screen information transmission unit 3803 continuously transmits the converted picture data to the picture display box 3400. In the present embodiment, the terminal device 101 is a terminal device capable of displaying the picture display box 3400 and capable of displaying still picture or moving picture in the picture display box 3400 as well. A data format of still picture or moving picture that can be displayed in the picture display box 3400 may not be the same as a data format of still picture or moving picture displayed in the picture display box 3300.

In the above-described remote operation systems of the respective embodiments, functions of the screen analysis unit, the screen information transmission unit, the operation execution unit and the screen change detection unit in the computer 100 to be operated and other functions can be realized not only by hardware but also by loading a computer program having each function into a memory of a computer processing device. The computer program is stored in a recording medium 108 such as a magnetic disc and a semiconductor memory. Then, loading the program from the recording medium into the computer processing device to control operation of the computer processing device realizes each of the above-described functions.

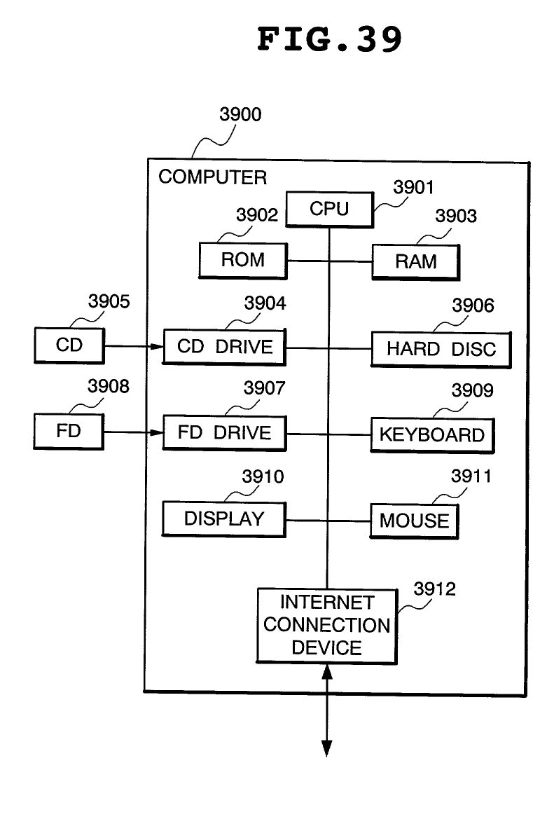

FIG. 39 is a block diagram showing one specific example of a device structure of the computer 100 to be operated in the present invention.

The computer 3900 of the example shown in FIG. 39 is connected to the communication network 102 of the Internet through the Internet connection device 3912 (modem, terminal adapter, dial-up router, etc.) which is the communication unit 107. This enables remote operation of the computer 100 from a PHS terminal or the like through the Internet. The computer is also provided with a display 3910 as a display device, a keyboard 3909 and a mousse 3911 as input devices.

In the example of FIG. 39, the computer program having the above-described functions of the present invention is recorded in each of various kinds of recording media such as a ROM 3902 (Read Only Memory), a hard disc 3906, a CD 3905 (Compact Disc) and an FD 3908 (Floppy Disc), read into an RAM 3903 (Random Access Memory) and executed by a CPU 3901 (Central Processing Unit). When the program is recorded in the CD 3905, it can be read through a CD drive 3904 and when the same is recorded in the FD 3908, it can be read through an FD drive 3907.

Although the present invention has been described with respect to the preferred embodiments and specific examples in the foregoing, the present invention is not limited to the above-described embodiments and specific examples and can be implemented as variations within a scope of the technical idea.

As described in the foregoing, the remote operation system of the present invention attains the following effects.

Firstly, the system enables even a portable terminal whose display size is small and whose information that can be displayed is a character only to conduct remote operation of a computer, thereby remotely operating arbitrary GUI application software running on the computer to be operated.

Secondly, since a display screen of a computer to be operated is appropriately converted into a hyper-text or a web page displayed by character data, which is transmitted to a user's terminal and whose operation is accepted by the same, the user's terminal needs not to have a special function for remote operation, so that a computer having the GUI environment can be remotely operated by freely selecting a terminal capable of communication and having a web browser or the like.

Thirdly, since from information of a screen of a computer to be operated, data such as a title name of an active window and a name of each item of a menu is obtained and converted into text data of the HTML text or the like and the converted data is notified, notification of detailed data is unnecessary such as a display position and configuration of each window and object, which notification is required in conventional systems, whereby communication costs can be drastically reduced.

Fourthly, since data of screen information of a computer to be operated is converted according to characteristics of a terminal device for use in remote operation, terminal devices having various characteristics are allowed to be used in remote operation of a computer. In other words, a terminal device usable for remote operation is not limited to a device having certain specific characteristics.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A remote operation system for remotely operating a device to be operated through a communication network from an operation side terminal, comprising:
screen analysis means for analyzing information displayed on a screen of said device to be operated, and
screen information transmission means for transmitting data of an analysis result obtained by said screen analysis means to said operation side terminal to display the data on said operation side terminal.

2. The remote operation system as set forth in claim 1, further comprising
operation execution means for causing said device to be operated to execute predetermined processing corresponding to user's operation conducted using said operation side terminal.

3. The remote operation system as set forth in claim 1, further comprising
screen information conversion means for converting data of an analysis result obtained by said screen analysis means into data suitable for the transmission to said operation side terminal or for displaying on a screen of said operation side terminal, wherein
said screen information transmission means transmits data of a result of conversion by said screen information conversion means to said operation side terminal to display the data on said operation side terminal.

4. The remote operation system as set forth in claim 3, further comprising
conversion rule registration means for registering and recording rules for converting data of an analysis result obtained by said screen analysis means into data suitable for the transmission to said operation side terminal or for displaying on the screen of said operation side terminal, wherein
said screen information conversion means converts data of an analysis result obtained by said screen analysis means based on the conversion rules recorded in said conversion rule registration means.

5. The remote operation system as set forth in claim 3, further comprising
device characteristic detection means for detecting device characteristics of said operation side terminal, wherein
said screen information conversion means converts data of an analysis result obtained by said screen analysis means based on device characteristics detected by said device characteristic detection means and conversion rules recorded in said conversion rule registration means.

6. The remote operation system as set forth in claim 1, further comprising
screen change detection means for detecting a change in display of the screen of said device to be operated, wherein
at a time when a change occurred in display of the screen is completed, said screen analysis means analyzes the current screen of said device to be operated.

7. The remote operation system as set forth in claim 1, wherein
said device to be operated is an information processing device having a GUI, and
said screen analysis means detects GUI widgets displayed on the screen of said device to be operated to obtain attribute data of said GUI widgets.

8. The remote operation system as set forth in claim 7, wherein
the attribute data of said GUI widgets includes at least one of a kind of said GUI widgets, a name of said GUI widgets and a location of said GUI widgets in the screen.

9. The remote operation system as set forth in claim 7, wherein
said conversion rule registration means has registration of rules for converting data of an analysis result obtained by said screen analysis means into a web page that can be displayed by a web browser,
said screen information conversion means converts data of an analysis result obtained by said screen analysis means into a web page based on said rules,
said web page includes, for GUI widgets operable by a user among GUI widgets detected by said screen analysis means, a hyper-link corresponding to the GUI widgets in question, and
when said hyper-link is selected, data for identifying GUI widgets corresponding to the hyper-link in question and data for identifying operation for the GUI widgets in question are transmitted to said operation execution means.

10. The remote operation system as set forth in claim 1, wherein
said conversion rule registration means has registration of rules for converting data of an analysis result obtained by said screen analysis means into a text of electronic mail.

11. The remote operation system as set forth in claim 10, wherein
said operation execution means receives electronic mail including information of user's operation conducted using said operation side terminal, analyzes the received electronic mail to identify the user's operation, and executes the operation in question.

12. The remote operation system as set forth in claim 1, wherein
data of an analysis result obtained by said screen analysis means is data of an XML format.

13. The remote operation system as set forth in claim 1, wherein
said operation side terminal is a portable communication terminal having a character data transmission and reception function.

14. The remote operation system as set forth in claim 1, wherein
said communication network is the Internet.

15. The remote operation system as set forth in claim 1, wherein
said screen analysis means, when moving picture or still picture is displayed on the screen of said device to be operated, detects the display in question to extract picture data of the display in question, and
said screen information transmission means transmits said picture data extracted by said screen analysis means to said operation side terminal to display the data on said operation side terminal.

16. The remote operation system as set forth in claim 1, wherein
said screen analysis means, when moving picture or still picture is displayed on the screen of said device to be operated, detects the display in question to extract picture data of the display in question, and
said screen information conversion means converts said picture data extracted by said screen analysis means into data suitable for the transmission to said operation side terminal or for displaying on the screen of said operation side terminal.

17. The remote operation system as set forth in claim 5, wherein
device characteristics of said operation side terminal detected by said device characteristic detection means include at least one of an inherent ID of said operation side terminal, a kind of machine, a processing rate, a communication rate, communication costs per unit volume of data, communication costs per unit time, a data format that can be displayed on a screen, a playable sound data format, executable program and script formats, a volume of data receivable at one time, a color that can be displayed, a character font that can be displayed, a screen resolution, a physical length of a screen in a vertical direction and a lateral direction and the number of characters that can be displayed within one screen in the vertical direction and the lateral direction.

18. A remote operation system for remotely operating a device to be operated through a communication network from an operation side terminal, wherein
said device to be operated comprises:
screen analysis means for analyzing the contents displayed on a screen of said device to be operated, and
screen information transmission means for transmitting data of an analysis result obtained by said screen analysis means to said operation side terminal to display the data on said operation side terminal.

19. The remote operation system as set forth in claim 18, further comprising
operation execution means for causing said device to be operated to execute predetermined processing corresponding to user's operation conducted using said operation side terminal.

20. The remote operation system as set forth in claim 18, further comprising
screen information conversion means for converting data of an analysis result obtained by said screen analysis means into data suitable for the transmission to said operation side terminal or for displaying on a screen of said operation side terminal, wherein
said screen information transmission means transmits data of a result of conversion by said screen information conversion means to said operation side terminal to display the data on said operation side terminal.

21. The remote operation system as set forth in claim 20, further comprising
conversion rule registration means for registering and recording rules for converting data of an analysis result obtained by said screen analysis means into data suitable for the transmission to said operation side terminal or for displaying on the screen of said operation side terminal, wherein
said screen information conversion means converts data of an analysis result obtained by said screen analysis means based on the conversion rules recorded in said conversion rule registration means.

22. The remote operation system as set forth in claim 20, further comprising
device characteristic detection means for detecting device characteristics of said operation side terminal, wherein
said screen information conversion means converts data of an analysis result obtained by said screen analysis means based on device characteristics detected by said device characteristic detection means and conversion rules recorded in said conversion rule registration means.

23. The remote operation system as set forth in claim 18, further comprising
screen change detection means for detecting a change in display of the screen of said device to be operated, wherein
at a time when a change occurred in display of the screen is completed, said screen analysis means analyzes the current screen of said device to be operated.

24. The remote operation system as set forth in claim 18, wherein
said device to be operated is an information processing device having a GUI, and
said screen analysis means detects GUI widgets displayed on the screen of said device to be operated to obtain attribute data of said GUI widgets.

25. The remote operation system as set forth in claim 24, wherein
the attribute data of said GUI widgets includes at least one of a kind of said GUI widgets, a name of said GUI widgets and a location of said GUI widgets in the screen.

26. The remote operation system as set forth in claim 24, wherein
said conversion rule registration means has registration of rules for converting data of an analysis result obtained by said screen analysis means into a web page that can be displayed by a web browser,
said screen information conversion means converts data of an analysis result obtained by said screen analysis means into a web page based on said rules,
said web page includes, for GUI widgets operable by a user among GUI widgets detected by said screen analysis means, a hyper-link corresponding to the GUI widgets in question, and
when said hyper-link is selected, data for identifying GUI widgets corresponding to the hyper-link in question and data for identifying operation for the GUI widgets in question are transmitted to said operation execution means.

27. The remote operation system as set forth in claim 18, wherein
said conversion rule registration means has registration of rules for converting data of an analysis result obtained by said screen analysis means into a text of electronic mail.

28. The remote operation system as set forth in claim 27, wherein
said operation execution means receives electronic mail including information of user's operation conducted using said operation side terminal, analyzes the received electronic mail to identify the user's operation, and executes the operation in question.

29. The remote operation system as set forth in claim 18, wherein
data of an analysis result obtained by said screen analysis means is data of an XML format.

30. The remote operation system as set forth in claim 18, wherein
said operation side terminal is a portable communication terminal having a character data transmission and reception function.

31. The remote operation system as set forth in claim 18, wherein
said communication network is the Internet.

32. The remote operation system as set forth in claim 18, wherein
said screen analysis means, when moving picture or still picture is displayed on the screen of said device to be operated, detects the display in question to extract picture data of the display in question, and
said screen information transmission means transmits said picture data extracted by said screen analysis means to said operation side terminal to display the data on said operation side terminal.

33. The remote operation system as set forth in claim 18, wherein
said screen analysis means, when moving picture or still picture is displayed on the screen of said device to be operated, detects the display in question to extract picture data of the display in question, and
said screen information conversion means converts said picture data extracted by said screen analysis means into data suitable for the transmission to said operation side terminal or for displaying on the screen of said operation side terminal.

34. The remote operation system as set forth in claim 22, wherein
device characteristics of said operation side terminal detected by said device characteristic detection means include at least one of an inherent ID of said operation side terminal, a kind of machine, a processing rate, a communication rate, communication costs per unit volume of data, communication costs per unit time, a data format that can be displayed on a screen, a playable sound data format, executable program and script formats, a volume of data receivable at one time, a color that can be displayed, a character font that can be displayed, a screen resolution, a physical length of a screen in a vertical direction and a lateral direction and the number of characters that can be displayed within one screen in the vertical direction and the lateral direction.

35. A remote operation method of remotely operating a device to be operated through a communication network from an operation side terminal, comprising the steps of:
a screen analysis step of analyzing information displayed on a screen of said device to be operated, and
screen information transmission step of transmitting data of an analysis result obtained by said screen analysis step to said operation side terminal to display the data on said operation side terminal.

36. The remote operation method as set forth in claim 35, further comprising
an operation execution step of causing said device to be operated to execute predetermined processing corresponding to user's operation conducted using said operation side terminal.

37. The remote operation method as set forth in claim 35, further comprising
a screen information conversion step of converting data of an analysis result obtained by said screen analysis step into data suitable for the transmission to said operation side terminal or for displaying on a screen of said operation side terminal, wherein
at said screen information transmission step, data of a result of conversion by said screen information conversion step is transmitted to said operation side terminal to display the data on said operation side terminal.

38. The remote operation method as set forth in claim 37, further comprising
a conversion rule registration step of registering rules for converting data of an analysis result obtained by said screen analysis step into data suitable for the transmission to said operation side terminal or for displaying on the screen of said operation side terminal, wherein
at said screen information conversion step, data of an analysis result obtained by said screen analysis step is converted based on the conversion rules registered at said conversion rule registration step.

39. The remote operation method as set forth in claim 37, further comprising
a device characteristic detection step of detecting device characteristics of said operation side terminal, wherein
at said screen information conversion step, data of an analysis result obtained by said screen analysis step is converted based on device characteristics detected by said device characteristic detection step and conversion rules registered at said conversion rule registration step.

40. The remote operation method as set forth in claim 35, further comprising
a screen change detection step of detecting a change in display of the screen of said device to be operated, wherein
at a time when a change occurred in display of the screen is completed, the contents displayed on the current screen of said device to be operated are analyzed by said screen analysis step.

41. The remote operation method as set forth in claim 35, wherein
said device to be operated is an information processing device having a GUI, and
at said screen analysis step, GUI widgets displayed on the screen of said device to be operated is detected to obtain attribute data of said GUI widgets.

42. The remote operation method as set forth in claim 41, wherein
the attribute data of said GUI widgets includes at least one of a kind of said GUI widgets, a name of said GUI widgets and a location of said GUI widgets in the screen.

43. The remote operation method as set forth in claim 41, wherein
at said conversion rule registration step, rules are registered for converting data of an analysis result obtained by said screen analysis step into a web page that can be displayed by a web browser,
at said screen information conversion step, data of an analysis result obtained by said screen analysis step is converted into a web page based on said rules,
said web page includes, for GUI widgets operable by a user among GUI widgets detected by said screen analysis step, a hyper-link corresponding to the GUI widgets in question, and
at said operation execution step, using data for identifying GUI widgets corresponding to the hyper-link in question and data for identifying operation for the GUI widgets in question which are transmitted when said hyper-link is selected, the operation side terminal is caused to execute predetermined processing.

44. The remote operation method as set forth in claim 35, wherein
at said conversion rule registration step, rules are registered for converting data of an analysis result obtained by said screen analysis step into a text of electronic mail.

45. The remote operation method as set forth in claim 35, wherein
at said screen analysis step, when moving picture or still picture is displayed on the screen of said device to be operated, the display in question is detected to extract picture data of the display in question, and
at said screen information transmission step, said picture data extracted by said screen analysis step is transmitted to said operation side terminal to display the data on said operation side terminal.

46. The remote operation method as set forth in claim 35, wherein
at said screen analysis step, when moving picture or still picture is displayed on the screen of said device to be operated, the display in question is detected to extract picture data of the display in question, and
at said screen information conversion step, said picture data extracted by said screen analysis step is converted into data suitable for the transmission to said operation side terminal or for displaying on the screen of said operation side terminal.

47. The remote operation method as set forth in claim 39, wherein
device characteristics of said operation side terminal detected by said device characteristic detection step include at least one of an inherent ID of said operation side terminal, a kind of machine, a processing rate, a communication rate, communication costs per unit volume of data, communication costs per unit time, a data format that can be displayed on a screen, a playable sound data format, executable program and script formats, a volume of data receivable at one time, a color that can be displayed, a character font that can be displayed, a screen resolution, a physical length of a screen in a vertical direction and a lateral direction and the number of characters that can be displayed within one screen in the vertical direction and the lateral direction.

48. A remote operation program for remotely operating a device to be operated through a communication network from an operation side terminal by controlling an information processing system, which causes execution of:
screen analysis processing of analyzing information displayed on a screen of said device to be operated, and
screen information transmission processing of transmitting data of an analysis result obtained by said screen analysis processing to said operation side terminal to display the data on said operation side terminal.

49. The remote operation program as set forth in claim 48, which causes execution of operation execution processing of making said device to be operated conduct predetermined processing corresponding to user's operation conducted using said operation side terminal.

50. The remote operation program as set forth in claim 48, which causes screen information conversion processing of converting data of an analysis result obtained by said screen analysis processing into data suitable for the transmission to said operation side terminal or for displaying on a screen of said operation side terminal, and
in said screen information transmission processing, causes execution of processing of transmitting data of a conversion result obtained by said screen information conversion processing to said operation side terminal to display the data on said operation side terminal.

51. The remote operation program as set forth in claim 50, which causes execution of conversion rule registration processing of registering rules for converting data of an analysis result obtained by said screen analysis processing into data suitable for the transmission to said operation side terminal or for displaying on the screen of said operation side terminal, and
in said screen information conversion processing, causes execution of processing of converting data of an analysis result obtained by said screen analysis processing based on the conversion rules registered by said conversion rule registration processing.

52. The remote operation program as set forth in claim 50, which causes execution of device characteristic detection processing of detecting device characteristics of said operation side terminal, and
in said screen information conversion processing, causes execution of processing of converting data of an analysis result obtained by said screen analysis processing based on device characteristics detected by said device characteristic detection processing and conversion rules registered by said conversion rule registration processing.

53. The remote operation program as set forth in claim 48, which causes execution of:
screen change detection processing of detecting a change in display of the screen of said device to be operated, and
at a time when a change occurred in display of the screen is completed, processing of analyzing the contents displayed on the current screen of said device to be operated by said screen analysis processing.

54. The remote operation program as set forth in claim 48, wherein
said device to be operated is an information processing device having a GUI, and
in said screen analysis processing, the program causes execution of processing of detecting GUI widgets displayed on the screen of said device to be operated to obtain attribute data of said GUI widgets.

55. The remote operation program as set forth in claim 54, wherein
the attribute data of said GUI widgets includes at least one of a kind of said GUI widgets, a name of said GUI widgets and a location of said GUI widgets in the screen.

56. The remote operation program as set forth in claim 54, wherein
in said conversion rule registration processing, rules are registered for converting data of an analysis result obtained by said screen analysis processing into a web page that can be displayed by a web browser,
in said screen information conversion processing, data of an analysis result obtained by said screen analysis processing is converted into a web page based on said rules,
said web page includes, for GUI widgets operable by a user among GUI widgets detected by said screen analysis processing, a hyper-link corresponding to the GUI widgets in question, and
in said operation execution processing, in order to cause the operation side terminal to execute said predetermined processing, data for identifying GUI widgets corresponding to the hyper-link in question and data for identifying operation for the GUI widgets in question transmitted when said hyper-link is selected.

57. The remote operation program as set forth in claim 48, which
in said conversion rule registration processing, causes execution of processing of registering rules for converting data of an analysis result obtained by said screen analysis processing into a text of electronic mail.

58. The remote operation program as set forth in claim 48, which causes execution of:
in said screen analysis processing, when moving picture or still picture is displayed on the screen of said device to be operated, detecting the display in question to extract picture data of the display in question, and
in said screen information transmission processing, processing of transmitting said picture data extracted by said screen analysis processing to said operation side terminal to display the data on said operation side terminal.

59. The remote operation program as set forth in claim 48, which
in said screen analysis processing, when moving picture or still picture is displayed on the screen of said device to be operated, detects the display in question to extract picture data of the display in question, and
in said screen information conversion processing, converts said picture data extracted by said screen analysis processing into data suitable for the transmission to said operation side terminal or for displaying on the screen of said operation side terminal.

60. The remote operation program as set forth in claim 52, wherein
device characteristics of said operation side terminal detected by said device characteristic detection processing include at least one of an inherent ID of said operation side terminal, a kind of machine, a processing rate, a communication rate, communication costs per unit volume of data, communication costs per unit time, a data format that can be displayed on a screen, a playable sound data format, executable program and script formats, a volume of data receivable at one time, a color that can be displayed, a character font that can be displayed, a screen resolution, a physical length of a screen in a vertical direction and a lateral direction and the number of characters that can be displayed within one screen in the vertical direction and the lateral direction.
